(19) United States
(12) Patent Application Publication
(10) Pub. No.: US 2016/0321951 A1
(43) Pub. Date: Nov. 3, 2016

(54) ELECTRONIC APPARATUS, SERVER, AND CONTROLLING METHOD THEREOF

(71) Applicant: Samsung Electronics Co., Ltd., Suwon-si (KR)

(72) Inventors: Jong-tae KIM, Suwon-si (KR); Sun-ah KIM, Seongnam-si (KR); Hyung-rae CHO, Seoul (KR); Ga-hyun JOO, Suwon-si (KR); Han-sung LEE, Seoul (KR); Jun-ho KOH, Suwon-si (KR); Kyoung-jin MOON, Suwon-si (KR); Chang-hyun LEE, Suwon-si (KR); Yong-hyun LIM, Suwon-si (KR)

(21) Appl. No.: 15/141,156

(22) Filed: Apr. 28, 2016

(30) Foreign Application Priority Data
Apr. 28, 2015 (KR) 10-2015-0059716

(51) Int. Cl. G09B 19/00; G06K 9/00; G09B 5/02; G06T 11/60

(52) U.S. Cl. CPC G09B 19/0092; G06T 11/60; G06K 9/00892; G09B 5/02

(57) ABSTRACT

An electronic apparatus is provided. The electronic apparatus includes a display, an input device configured to receive user identification information, a sensor configured to sense characteristics of food placed on the electronic apparatus, and a processor configured to control to the display to display a user dietary guide based on user information corresponding to the user identification information and the characteristics of food.

### CROSS-REFERENCE TO RELATED APPLICATION(S)

This application claims the benefit under 35 U.S.C. §119(a) of a Korean patent application filed on Apr. 28, 2015 in the Korean Intellectual Property Office and assigned Serial number 10-2015-0059716, the entire disclosure of which is hereby incorporated by reference.

### TECHNICAL FIELD

The present disclosure relates to an electronic apparatus, a server, and a controlling method thereof. More particularly, the present disclosure relates to a display apparatus which may assist appropriate eating, a server which communicates with the electronic apparatus, and a controlling method thereof.

### BACKGROUND

Recently, with the development of information and communications technologies (ICT), an environment where people are connected via network anytime anywhere using various types of devices which go beyond a standardized-type device has been settled.

Under these circumstances, there has been growing interest in internet of things, and as mobile devices such as a smart phone, a tablet personal computer (PC), etc. are widely distributed and smart devices are expanded so as to produce a smart watch, smart glasses, a smart car, etc., an environment where various things are connected to internet and are subject to smart devices is created. In addition, an input technology of human cognition information such as a computer vision technology, a biometric signal, etc. has been developed and thus, an environment where various input information can be analyzed is created, replacing the existing input method.

Meanwhile, in this modern society, interest in individual health is growing, and in particular, people are paying more attention to dietary management these days as the culture of well-being has been emerged.

Accordingly, ICT is fast converged into dietary devices, etc. in the field related to the dietary industry, and various products and services are introduced to help users eat food properly since it is directly related to the users' health. For example, recently, there are various attempts to utilize a sensor network such as a smart refrigerator, a smart cooking utensils, etc., and a mobile analyzer to analyze ingredients of food (sugar level, calorie, protein, fat, etc.) using near-infrared spectrometry and inform users of the ingredients has been developed.

However, such a device simply provides information regarding food ingredients, and there is no dietary device to guide users to control their diet naturally and thus, encourage them to go on a diet, improve dietary habit, etc.

Accordingly, a method for providing a diet assistance service is required so that when users eat food, they can maintain proper diet in accordance with their individual dietary management purpose.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide an electronic apparatus which may recognize a user and guide the user to achieve his or her dietary goal, a server, and a controlling method thereof.

In accordance with an aspect of the present disclosure, an electronic apparatus is provided. The electronic apparatus includes a display, an input device configured to receive user identification information, a sensor configured to sense characteristics of food placed on the electronic apparatus, and a processor configured to control to the display to display a user dietary guide based on user information corresponding to the user identification information and the characteristics of food.

The display may display the user dietary guide one at least one of an outer side and an inner side of the electronic apparatus where food is placed.

The display may be implemented as at least one of a transparent display and a curved display having a curvature corresponding to a circumference of the electronic apparatus.

The user information may include at least user's body information, user's dietary history information and user's goal setting information.

The user dietary guide may include at least one of a food intake guide, an unbalanced diet guide and an eating speed guide.

The processor may control to display a screen including the food intake guide on the display, and the screen including the food intake guide may display a predetermined color or content corresponding to improvement of appetite or loss of appetite on an entire area or a partial area of the display.

The processor may control to display a screen including the food intake guide on the display, and the screen including the food intake guide may be displayed such that an edge area of the display has predetermined transparency.

The processor may control to display the screen including the food intake guide on the display, and the screen including the food intake guide may display guidelines corresponding to the user's recommended intake.

The processor may control to display the screen including the food intake guide on the display, and the screen including the food intake guide may display at least one of calorie information of the food, calorie information of the food consumed so far and information on minimum exercise required to burn calorie intake.

The processor may control to display a screen including the unbalanced diet on the display, and the screen including the unbalanced diet guide may provide a visual feedback regarding food with less intake.

The sensor may include at least one of a weight sensor and an illumination sensor, and the processor may detect an area which is not covered by the food on the display using at least one of the weight sensor and the illumination sensor, and control to display the user dietary guide on an area which is not covered by the food.

The apparatus may further include a transceiver configured to communicate with utensils for picking up food, and the processor may control to provide a visual feedback corresponding to a user's dietary habit based on movement information of the utensils received through the transceiver.

The transceiver may communicate with at least one of other electronic apparatuses, and the processor may control to provide a visual feedback corresponding to the user's dietary habit which is determined based on at least one of the movement information of the utensils and food intake information received from at least one of the other electronic apparatuses through the transceiver.

The sensor may include at least one of a camera which captures the food placed on the electronic apparatus, an ingredient detector which detects ingredients of the food, a salinity sensor, a temperature sensor, a pH sensor, an illumination sensor, and a weight sensor.

The apparatus may further include a transceiver configured to communicate with a server, and the processor may control to transmit a food image captured by the camera to the server through the transceiver, receive food information corresponding to the food image from the server, and display the user's dietary guide corresponding to the received food information.

The apparatus may further include a memory, and the processor may control to display the user's dietary guide based on user information corresponding to the user identification information and the food characteristics from among user information stored in the memory.

The input device may include a biometrics recognition sensor, and the user identification information may be biometric information detected by the biometrics recognition sensor.

The apparatus may further include a transceiver configured to communicate with a server, and the processor may control to transmit user identification information to the server and receive user information corresponding to the user identification information from the server.

In accordance with another aspect of the present disclosure, a server is provided. The server includes a memory configured to store user information, a transceiver configured to communicate with an electronic apparatus where food is placed, and a processor configured to control to receive user identification information and food information corresponding to characteristics of the food from the electronic apparatus through the transceiver, and transmit user's dietary guide displayed on a display of the electronic apparatus to the electronic apparatus based on user information corresponding to the user identification information and the food information.

In accordance with another aspect of the present disclosure, a controlling method of an electronic apparatus is provided. The controlling method includes receiving user identification information, sensing characteristics of food placed on the electronic apparatus, and displaying user's dietary guide based on user information corresponding to the user identification information and the characteristics of food.

According to the above-described various embodiments, it is possible to guide a user to maintain healthy diet according to individual dietary management purpose by recognizing a user.

Other aspects, advantages, and salient features of the disclosure will become apparent to those skilled in the art from the following detailed description, which, taken in conjunction with the annexed drawings, discloses various embodiments of the pre sent disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1A is a block diagram illustrating configuration of an electronic apparatus briefly according to an embodiment of the present disclosure;

FIG. 1B is a block diagram illustrating configuration of an electronic apparatus briefly according to an embodiment of the present disclosure;

FIGS. 2A to 2C are exploded perspective views of an electronic apparatus according to an embodiment of the present disclosure;

FIG. 3 is a view provided to explain elements included in an inner side of an electronic apparatus according to an embodiment of the present disclosure;

FIG. 4 is a view provided to explain elements included in an external side of an electronic apparatus according to an embodiment of the present disclosure;

FIGS. 5 and 6A to 6B are flowcharts provided to explain a guide-type determining method according to various embodiments of the present disclosure;

FIG. 7 is a flowchart provided to explain a method of displaying a predetermined color on a display in consideration of a diet purpose according to an embodiment of the present disclosure;

FIGS. 8A to 8C are views provided to explain a method of providing an optical illusion effect with respect to the amount of food in consideration of a diet purpose according to an embodiment of the present disclosure;

FIG. 8D is a flowchart provided to explain the method of proving an illusion effect according to an embodiment of the present disclosure;

FIGS. 8E to 8H are views provided to describe an embodiment of providing an optical illusion effect according to an embodiment of the present disclosure;

FIGS. 9A and 9B are views provided to explain a method of displaying guidelines corresponding to recommended nutrition intake in consideration of a diet purpose according to an embodiment of the present disclosure;

FIGS. 10 and 11 are views provided to explain a method of changing colors displayed on a display in consideration of a diet purpose according to an embodiment of the present disclosure;

FIGS. 12 to 13 are views provided to explain a method of providing information regarding calorie in consideration of a diet purpose according to an embodiment of the present disclosure;

FIGS. 14, 15, and 16 are views provided to explain a method of sensing a movement of utensils linked to an electronic apparatus according to an embodiment of the present disclosure;

FIGS. 17A to 17C are views provided to explain a method of sensing a movement of utensils linked to a plurality of electronic apparatuses according to an embodiment of the present disclosure;

FIG. 18 is a view provided to explain a method of displaying various contents by an electronic apparatus according to an embodiment of the present disclosure;

FIG. 19 is a view provided to explain a method of recommending food by an electronic apparatus according to an embodiment of the present disclosure;

FIGS. 20 and 21 are views provided to explain a method of guiding a user to concentrate eating and improve an unbalanced diet by causing his or her interest through a display according to an embodiment of the present disclosure;

FIG. 22 is a view provided to explain a method of improving an unbalanced diet by increasing preference regarding a specific food unconsciously according to an embodiment of the present disclosure;

FIG. 23 is a view provided to explain a method of guiding the diet of a patient with brain dysfunction according to an embodiment of the present disclosure;

FIG. 24 is a view provided to explain a method of informing a user of a sanitary state of an electronic apparatus according to an embodiment of the present disclosure;

FIG. 25 is a view provided to explain a method of informing a user of freshness of food placed on an electronic apparatus according to an embodiment of the present disclosure;

FIG. 26 is a view provided to explain an electronic apparatus which provides information regarding ingredients of food placed on an electronic apparatus and a purchase button according to an embodiment of the present disclosure;

FIG. 27 is a view provided to explain an electronic apparatus which provides guidelines in consideration of food included in an electronic apparatus according to an embodiment of the present disclosure;

FIG. 28 is a view provided to explain an operation method of an electronic apparatus which is implemented as a table according to an embodiment of the present disclosure;

FIGS. 29 and 30 are views provided to explain an operation of an electronic apparatus which is linked to a wearable apparatus, etc. in internet of things environment according to an embodiment of the present disclosure;

FIG. 31 is a block diagram illustrating configuration of a server which performs communication with an electronic apparatus briefly according to an embodiment of the present disclosure;

FIG. 32 is a block diagram illustrating configuration of an electronic apparatus in detail according to an embodiment of the present disclosure; and

FIG. 33 is a flowchart provided to explain a method of controlling an electronic apparatus according to an embodiment of the present disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

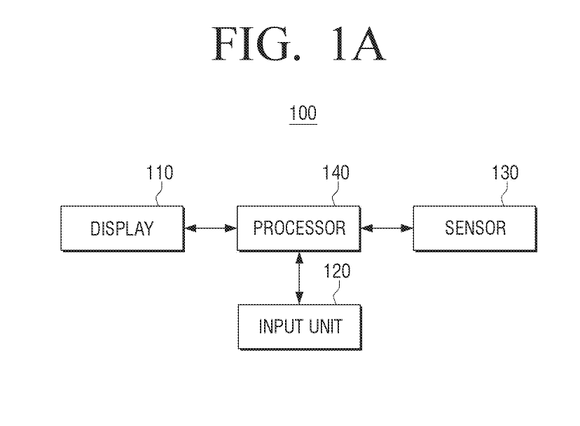

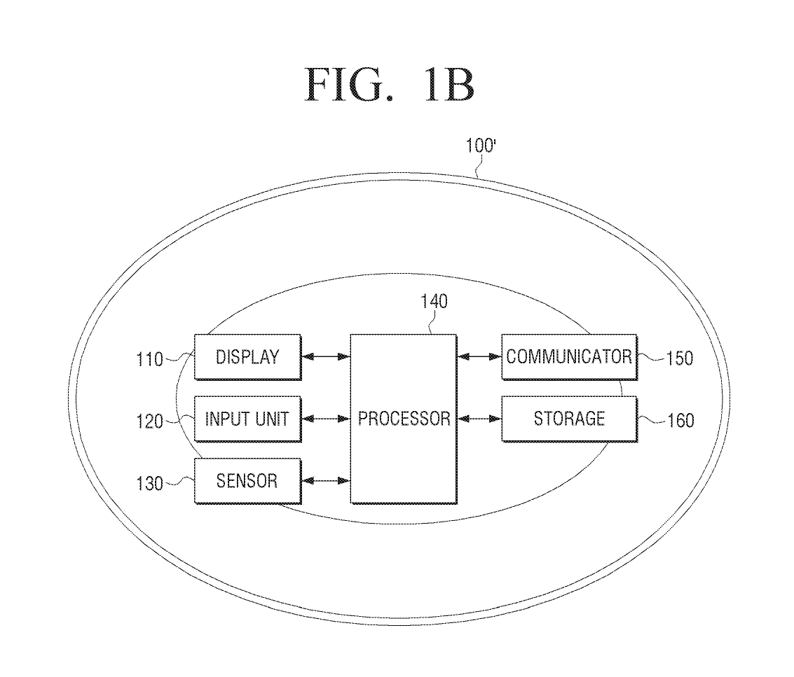

FIG. 1A is a block diagram illustrating configuration of an electronic apparatus briefly according to an embodiment of the present disclosure.

Referring to FIG. 1A, an electronic apparatus 100 according to an embodiment is a smart device which displays user's dietary guide to guide the user to healthy diet based on user information regarding the user and characteristics of food, and may be a dish-type device in the form of plate so that food can be placed therein. However, the shape of the electronic apparatus 100 is not limited thereto, and the electronic apparatus 100 may be implemented as various types of food container such as a bowl, a container, a cup, etc.

According to an embodiment, the electronic apparatus 100 is implemented as a dish-type device in the form of circular plate, but is not limited thereto. The electronic apparatus 100 may be formed in various types of plates including polygon such as triangle, square, etc. Here, the inner side of the electronic apparatus 100 may be configured in a plane surface or a down-concave curved surface.

In addition, the electronic apparatus 100 according to an embodiment may be implemented as a food container where food is placed directly or a table-type device where a device such as a food container is placed. As such, the electronic apparatus 100 may be implemented as various forms of devices.

In this case, the electronic apparatus which is implemented as in the form of dish-type plate may be referred to as an electronic plate, an electronic dish, an electronic saucer, etc. In addition, the electronic apparatus in the form of various food containers such as a bowl, a container, a cup, etc. may be referred to as an electronic bowl, an electronic container, an electronic cup, etc. Meanwhile, if the electronic apparatus is configured in the form of table where a food container, etc. can be placed, the electronic apparatus may be referred to as an electronic table.

Meanwhile, considering their expanded functions, the above-described electronic plate, electronic dish, electronic saucer, electronic bowl, electronic container, electronic cup, electronic table, etc. may be referred to as smart plate, smart saucer, smart bowl, smart container, smart cup, smart table, etc., respectively.

In the following various embodiments, otherwise specifically described, it is assumed that the electronic apparatus according to an embodiment is configured in the form of dish. However, the various embodiments are not limited thereto and as described above, it is obvious that the technical feature of the present disclosure is applied to the electronic apparatuses which are implemented in various forms.

Referring to FIG. 1A, the electronic apparatus 100 according to an embodiment includes a display 110, an input unit 120, a sensor 130, and a processor 140.

The display 110 displays information. In particular, the display 110 may display various information which can guide user's dietary habit under the control of the processor 140. The display 110 may be provided at least one of the inner side where food is placed and outer side which is opposite to the inner side and display various information for the user who eats food. In general, food is placed inside an apparatus and thus, if the smart apparatus 100 is implemented as a dish-type apparatus, the inner side corresponds to the front side which is an upper part of the smart apparatus 100 and the outer side corresponds to the rear side which is a bottom part of the smart apparatus 100.

The display 110 may be implemented as liquid crystal display panel (LCD panel), organic light emitting diodes (OLEDs), transparent display, flexible display, etc., but is not limited thereto. In addition, the display 110 may further include a driving circuit, a backlight unit, etc. which can be embodied in the form of amorphous silicon thin film transistor (a-si TFT), low temperature poly silicon (LTPS) TFT, organic TFT (OTFT), etc. In particular, it is desirable that the display 110 according to an embodiment is realized as a transparent display and a curved display having a curvature corresponding to the circumference of the electronic apparatus 100.

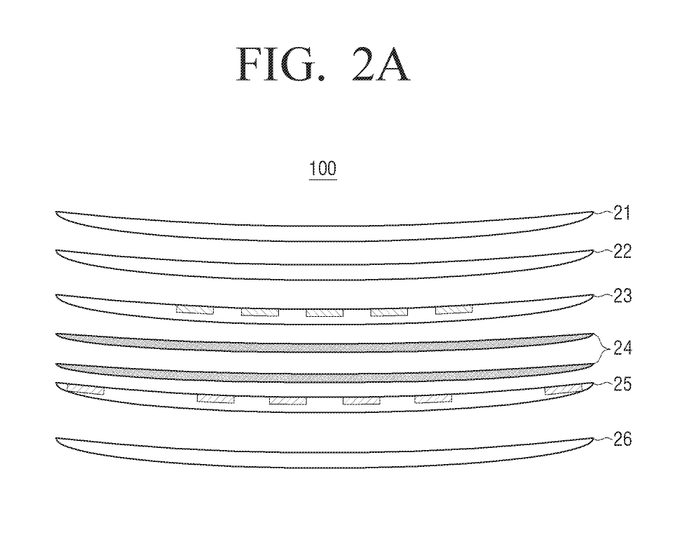

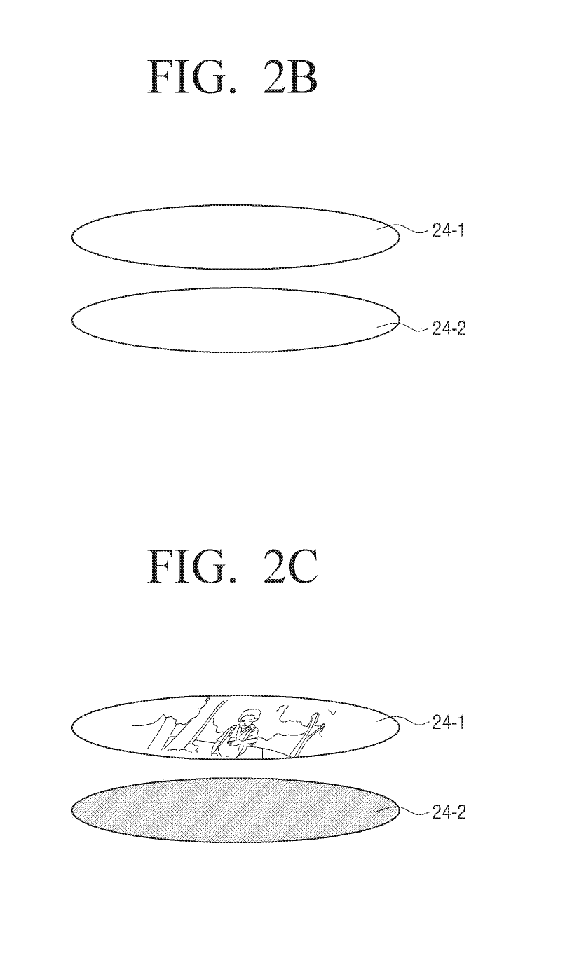

Meanwhile, as described below, the display 110 may be realized as a duel display where a plurality of display panels are overlapped, and the detailed description thereof will be provided with reference to FIGS. 2C and 2B.

In addition, according to an embodiment, the display 110 is configured to be provided on at least one if the inner side of the electronic apparatus 100 where food is placed and the outer side which is opposite to the inner side so that the screen displaying user's dietary guide covers at least one of the entire area of the inner side and the outer side, but this is only an example. The display 110 may be provided only part of the inner side where food is placed or part of the outer side.

The input unit 120 senses a user interaction to control the overall operations of the electronic apparatus 100 and may receive user identification information to identify a user. The input unit 120 may alternatively be referred to as an input device.

Specifically, the input unit 120 may acquire user identification information by at least one of a user input and a biometric input sensor. Here, the user identification information refers to information for identification of a user's individual identity, and may consist of a part or in combination of number, character, symbol, etc. to inform who the user is. In addition, the user identification information may include information for authentication of the user.

Specifically, the user identification information may refer to traditional intrinsic identification information based on identifier (ID) and password including e-mail address, mobile phone number, etc., and may also include information based on physical data regarding intrinsic physical characteristics which are different from person to person, such as a user's fingerprint, voice, iris, vein, face, etc. In addition, the user identification information may include information regarding gender, age, etc. according to the purpose of identification. In this case, generally, it is desirable that the user identification is performed before meals.

For example, the user identification may be conducted by performing authentication by inputting ID, password, etc. through the input unit 120 which is implemented as hardware or software in the electronic apparatus 100 before meals. If the input unit 120 is implemented based on hardware, ID, password, etc. may be input through button, touch pad, etc. provided on one side of the electronic apparatus 100. Here, it is desirable that the button or the touch pad is provided on one area of the outer side of the electronic apparatus 100.

If the display 110 is realized as a touch screen including a touch sensor, the input unit 120 may be implemented based on software. In this case, the user identification may be conducted as various user identification information including ID and password is input through an input such as touch, drag, etc. on the touch screen. In this case, a guide option screen where a speech balloon in the form of question is displayed may be provided on the display 110 to receive user identification information, user information, etc. from the user.

Meanwhile, the user identification may be acquired through biometrics recognition. In other words, the electronic apparatus 100 may perform the user identification by extracting user's unique biometric information and make it user information and to do so, the input unit 120 may include a biometrics recognition sensor.

The biometrics recognition may be performed through various methods such as fingerprint scanning, vein recognition, iris recognition, voice recognition, face recognition, etc. and to do so, the input unit 120 may include various sensors such as a fingerprint recognition sensor, a vein recognition sensor, an iris recognition sensor, a voice recognition sensor, a face recognition sensor, etc.

In addition, the electronic apparatus may include a communicator (not illustrated) in addition to the input unit 120 and receive user identification information from an external apparatus or a server. The communicator may alternatively be referred to as a transceiver. For example, user identification may be performed by receiving user identification information such as an authentication key, etc. from various external apparatuses such as a user's smart phone, a wearable device, etc. which performs communication with the electronic apparatus 100 through a near field wireless communication means such as near field communication (NFC). In this case, the user identification information may include account information which is set in advance for each user in order to identify each of a plurality of users, which will be described in detail later.

Meanwhile, the user identification is not limited to the above-described methods, and the user identification may also be performed through various methods where data or information regarding a user can be received or input.

The sensor 130 senses characteristics of food which is placed on the electronic apparatus 100. Here, the food refers to food or groceries containing one or more nutrients, and includes everything that human can cook to eat or drink, eat or drink. In addition, the food characteristics may refer to various characteristics such as the type of food, ingredients, color, salinity, temperature, pH, size, hardness, weight, amount of moisture, etc.

The sensor 130 may include at least one of a camera which captures food placed on the electronic apparatus 100, an ingredient detector which detects ingredients of the food, a salinity sensor, a temperature sensor, a pH sensor, an illumination sensor and a weight sensor which detect an area where the food is placed, and may be configured to be built in the display 110. The data regarding food characteristics which is sensed through the sensor 130 may be used as basic information to guide a user's diet.

Meanwhile, in the above embodiment, food characteristics are sensed through the sensor 130, but information regarding food characteristics may be input directly by a user through the input unit 120. For example, a user may directly select or input information (type, color, calorie, etc.) regarding the characteristics of food he or she wishes to eat through the display 100 which is implemented as a touch screen. In this case, the display 110 may display a speech balloon, etc. to receive food characteristics from a user.

In addition, the information regarding food characteristics may be input by a user's voice through a microphone provided on the electronic apparatus 100 (“This is tomato spaghetti”). Alternatively, the electronic apparatus 100 may receive a food code such as a barcode displayed on the wrapper of the food and acquire characteristics of the food. To do so, the electronic apparatus 100 may include a barcode reader. Further, the electronic apparatus 100 may receive information regarding characteristics of food corresponding to a barcode by capturing and recognizing the barcode through the camera.

In addition, a user may select or input information regarding food through an external apparatus such as a smart phone, a wearable device, etc., and transmit the corresponding information to the electronic apparatus 100. For example, the electronic apparatus 100 may receive data or information regarding food characteristics which is sensed by smart chopsticks which can sense the temperature, pH, etc. of the food.

In this case, the electronic apparatus 100 may guide a user's diet based on data or information regarding food characteristics which is input or received.

Meanwhile, the electronic apparatus 100 may include an electronic tag reader and receive information regarding food characteristics through the electronic tag reader. Specifically, the electronic apparatus 100 may tag an electronic tag attached to a food container using the electronic tag reader and receive information regarding food characteristics corresponding to the electronic tag. In this case, the electronic tag attached to the food container may include information regarding characteristics corresponding to the food included in the container in advance.

In this case, in order to recognize each tag, near field communication technology such as wireless local area network (LAN), Wi-Fi, Bluetooth, ZigBee, Wi-Fi direct (WFD), ultra wideband (UWB), infrared data association (IrDA), Bluetooth low energy (BLE), NFC, etc. can be utilized, and the electronic tag reader which senses a container may include radio frequency identification (RFID) reader, NFC reader, Bluetooth reader, etc. However, the NFC technology is not limited to the above technologies, and may include various NFC technologies.

The processor 140 controls the overall operations of the electronic apparatus 100.

In particular, the processor 140 may identify a user based on user identification information which is input through the input unit 120, and if the user is identified, control the display 110 to display the user's dietary guide to guide the user's diet based on the user information corresponding to the identified user and the sensed food characteristics.

Here, the user information may include at least one of user's body information, user's dietary history information and user's goal setting information.

The user's body information refers to information regarding height, weight, age, gender, etc. of the identified user, and may include body mass index (BMI) which is calculated using the user's height and weight. In addition, the user's body information may include information regarding diseases such as high blood pressure, diabetes, etc., and whether the user is suffering from any disease, disabilities, allergy, etc. For example, the processor 140 may provide information regarding recommended food to lower a blood sugar level based on the information that the user has high blood pressure and provide a feedback regarding food which may cause high blood pressure.

Such user's body information may be acquired by directly receiving input from a user through the input unit 120 or may be received in communication with an external apparatus such as a smart phone. For example, if an application for health care which is used in a smart phone, etc. is executed, the electronic apparatus 100 may request and receive user's body information, etc. of the user which is input or registered in the application.

The user's dietary history information refers to information storage regarding the type and amount of food that the user has consumed for a certain period of time and based on this information, the user's diet may be managed regularly by guiding the user's dietary habit.

The user's goal setting information may include information regarding the type of guide which is set in accordance with the user's dietary improvement goal, guide period, information regarding a target weight, etc.

Here, the guide type may be divided into a food intake guide to control food intake such as diet, an unbalanced eating guide to improve unbalanced eating and an eating speed guide to control an eating speed. In this case, a user may set the type of guide in accordance with his or her dietary improvement purpose. Subsequently, whenever the electronic apparatus 100 is used, the guide type of the electronic apparatus 100 may set automatically according to setting information for each guide type.

As described above, the guide type may be set directly by a user, or may be determined based on user information such as user's body information, user's dietary history information, user's goal setting information, etc.

In this case, the processor 140 may control the display 110 to display a user's dietary guide including at least one of a food intake guide, an unbalanced eating guide and an eating speed guide based on the guide type.

Meanwhile, such user information may be stored in a storage (not illustrated) included in the electronic apparatus 100, or may be received from an external apparatus which communicates with the electronic apparatus 100, such as a smart phone, smart chopsticks, a smart spoon, various wearable devices, etc., or a server. The storage may alternatively be referred to as a memory.

The processor 140 may control the display 110 to display a user's dietary guide based on user information corresponding to user identification information. For example, a guide type which is predetermined by a user may be a guide to control food intake, that is, a guide for the user's diet.

In addition, the processor 140 may determine that the user needs to control food intake based on the user's body information such as BMI. For example, if the user's BMI is higher than normal, the processor 140 may control to display a user's dietary guide to guide the user to control food intake.

In addition, if the guide type set by a user is, for example, an unbalanced eating guide to improve unbalanced eating, or if it is determined that intake of specific food or specific nutrients is insufficient based on user information, the processor 140 may determine that the guide type is the unbalanced eating guide.

In addition, if the guide type is a food intake guide to control food intake or if it is determined that a user needs to control food intake based on user information, the processor 140 may determine that the guide type is the food intake guide. Here, a screen including the food intake guide may be a screen where a predetermined color or content corresponding to appetite improvement or appetite loss is displayed on the entire area or on a partial area. In this case, the processor 140 may provide an effect of reducing appetite by controlling to change the color displayed on the display 110 to a reddish color.

The reason why the display 110 is controlled to be displayed in a reddish color is because the red color is associated with “danger or prohibition” in a society, and it is proven by an experiment (The Journal Appetite, The University of Parma of Italy, 2014) that when food is placed in a red dish, the food becomes less attractive, thereby reducing food intake. Such an effect is described in detail in the cited thesis, so detailed description thereof will not be provided.

Meanwhile, the processor 140 may control the display 110 to display a specific color such as a blue color, and may control to display a color which may increase attractiveness of food to increase appetite.

The processor 140 may control the display 110 to display a content which may provide an effect of appetite improvement or appetite loss. Specifically, the processor 140 may control the display 110 to display a pattern, an image or a video which may provide the effect of appetite improvement or appetite loss. For example, the display 110 may display an image where a user's face is synthesized with the face of an overweight person or an image showing a slim person in a bikini to provide an effect of reducing the user's appetite.

In addition, the processor 140 may provide an appetite loss effect by controlling to display a complementary color regarding a food color, which will be described in detail later.

Meanwhile, a screen including a food intake guide may be displayed such that the edge area of the display 110 is displayed in predetermined transparency.

Specifically, the processor 140 may adjust the opacity of an area of the edge of the display 110 to be “0” so that the edge area is displayed transparently. Accordingly, the illusion effect where the diameter of the electronic apparatus 100 appears to be shorter may be provided to the user.

The above embodiment is based on an experiment result (Delboeuf illusion; the journal of Consumer Research, Cornell University & Georgia Institute of Technology) which shows that when food is placed in a big dish, the amount of the food appears to be smaller than when the food is placed in a small dish, causing the user to eat more food. Accordingly, the electronic apparatus 100 may encourage the user to put less food on the electronic apparatus 100. Such an effect is described in detail in the cited thesis, so detailed description thereof will not be provided.

In addition, a screen including the food intake guide may be a screen which displays guidelines corresponding to the user's recommended food intake. In this case, the guidelines may be displayed in a looped curve in the form of circle, and may guide the user to put food within the displayed guidelines.

Further, a screen including the food intake guide may be a screen which displays at least one of calorie information of the food, calorie information of the food consumed so far and information on minimum exercise required to burn calorie intake.

Specifically, the processor 140 may calculate information related to the calories of the food placed on the electronic apparatus 100 based on the type and characteristics of the food sensed through the sensor 130 and display the calculated information. In addition, the processor 140 may measure the change in amount of the food based on the change in weight which is sensed by using a weight sensor (not illustrated) provided on part of the inner side or a plurality of areas of the electronic apparatus 100. Here, the weight sensor may include a resistive sensor, and the resistive sensor may include contact resistance where resistance changes according to pressure. In this case, when pressure is applied to contact resistance by the food, the resistive sensor may measure the weight of the food based on the amount of change of the pressure corresponding to the value of the changed contact resistance. Here, the resistive sensor may be implemented as a resistive touch sensor.

The processor 140 may calculate information related to calories which are consumed by a user based on the amount of weight change which has been measured, and display the calculated information in real time or at predetermined intervals. For example, the processor 140 may control to display information regarding minimum amount of exercise which is required to burn the consumed calories (for example, 20 minutes of running, etc.) in order to raise awareness of overeating to the user.

In addition, the screen including an unbalanced eating may provide a visual feedback regarding the food of which intake is small. For example, the electronic apparatus 100 may detect the ingredients of the food which is placed in the electronic apparatus 100 and if it is determined that the detected ingredients is the type of ingredients the user needs to eat more, may control the display 110 to provide a visual feedback such as a specific color, a flickering effect, etc. Accordingly, the electronic apparatus 100 may guide the user to have more food of which intake is small.

Meanwhile, the electronic apparatus 100 may provide an auditory or tactual feedback using a speaker or a motor performing an oscillation function in addition to the above-described visual feedback.

The screen including a dietary guide may be provided at various points of time such as at a time when a user picks up the electronic apparatus 100, at a time when food is placed on the electronic apparatus 100, at a time when the weight of food is decreased, at a time when eating is finished (for example, when the weight of food becomes “0”), etc., which will be described in detail later.

FIG. 1B is a block diagram illustrating configuration of an electronic apparatus briefly according to an embodiment of the present disclosure.

Referring to FIG. 1B, an electronic apparatus 100′ according to an embodiment may further include a communicator 150 and the storage 160 in addition to the display 110, the input unit 120, the sensor 130, and the processor 140. The descriptions regarding the elements which are overlapped with those in FIG. 1A will not be provided.

The communicator 150 performs communication with at least one of a server and an external apparatus. The communicator 150 may perform communication with a server or an external apparatus through various communication methods such as RF including Bluetooth, Wi-Fi, ZigBee, NFC, infrared (IR), etc., and to do so, may include at least one communication element from among a ZigBee communication element, a Bluetooth communication element and a Wi-Fi communication element.

In particular, the communicator 150 may perform communication with a server (not illustrated) and receive information regarding food placed on the electronic apparatus 100′ from the server. Specifically, the processor 140 may control to capture the food placed on the electronic apparatus 100′ using a camera (not illustrated) included in the sensor 130 and transmit the captured food image to the server through the communicator 150.

The server may search information regarding the corresponding food based on the received food image and transmit the search result to the electronic apparatus 100′, and the processor 140 may receive the searched information regarding the food from the server and control the display 110 to display a user's dietary guide corresponding to the food information.

Meanwhile, the communicator 150 may perform communication with a server which stores user information. In this case, the server may store user information for each of a plurality of users. In this case, if user identification information is input, the processor 140 may control to transmit the input user identification information to the server. The server may transmit user information corresponding to the received user identification information from among pre-stored user information for each of a plurality of users to the electronic apparatus 100′. When the user information is transmitted to the electronic apparatus 100′, the processor 140 control the display 110 to display a user's dietary guide based on the received user information.

In addition, the communicator 150 may further perform communication with an external apparatus (not illustrated). Here, the external apparatus may include smart phone, personal digital assistant (PDA), notebook personal computer (PC), tablet PC, mobile terminal apparatus, etc. For example, the communicator 150 and an external apparatus may perform pairing, etc. using an RF signal. The representative pairing method using an RF signal includes ZigBee, Bluetooth communication method, etc.

The communicator 150 may receive user identification information from an external apparatus which is pre-registered in the electronic apparatus 100′. In other words, the electronic apparatus 100′ may perform user authentication by receiving ID, pin number, etc. directly from a user or by receiving user identification information such as an authentication key from an external apparatus which is in an area capable of performing communication without sensing the user's biometric information in order to identify the user.

When the user is identified, the electronic apparatus 100′ may further receive user information corresponding to the user identification information from an external apparatus which stores the user information.

The storage 160 stores user information. Specifically, the storage 160 may store user's body information, user's dietary history information, user's goal setting information, user's food preference information, etc.

The electronic apparatus 100′ may acquire user information corresponding to user identification information from among a plurality of user information which is stored in the storage 160. However, as described above, the electronic apparatus 100 may receive user information through a server.

The storage 160 may update the stored user information at every meal. The user's body information may be updated by receiving re-inputs through the input unit 120 or by receiving information from an external apparatus. In addition, all information related to diet which is sensed from the electronic apparatus 100′ is stored automatically whenever eating is finished and accordingly, the user's dietary history information may be updated.

FIGS. 2A to 2C are exploded perspective views of an electronic apparatus according to an embodiment of the present disclosure.

Referring to FIG. 2A, the electronic apparatus 100 consists of tempered glasses 21, 26 which cover the inner side and the outer side of the electronic apparatus 100, a touch sensor 22 disposed below the tempered glass 21 covering the inner side, a first element panel 23 disposed below the touch sensor 22, a display panel 24 disposed below the first element panel 23, a second element panel 25 disposed below the display panel including the processor 140, etc. In addition, a separate combination element to combine or connect each of the above-described elements 21˜26 may be provided. Specifically, a sealing means to prevent leakage on the connection sides of each element 21˜26 may be added, and a predetermined protrusion, groove, etc. in the close-fit form may be formed in order to improve convenience of connection process and prevent leakage.

The tempered glasses 21, 26 are provided to prevent scratch which is generated by friction with utensils such as fork or knife or breakdown by insertion of water during dish washing. In addition, the tempered glasses 21, 26 may prevent displayed information from being invisible. The tempered glasses 21, 26 may be made of other materials having transparency and accordingly, may be replaced with tempered plastic, protection film, etc.

The touch sensor 22 touches various touch inputs by a user. The touch sensor 22 may sense various inputs such as a single or a multi-touch input using various objects like finger, electronic pen, etc., a drag input, a writing input, a drawing input, etc. The touch sensor 22 may be implemented by using one panel capable of sensing both a finger input and a pen input, or may be implemented by using two panels such as a touch panel capable of sensing a finger input and a pen recognition panel capable of sensing a pen input.

A user may input user identification information to identify the user, user information, etc. using the touch sensor 22.

In addition, the touch sensor 22 includes a resistive sensor or resistive-type touch sensor in the form of transparent thin film. As sensing pressure on food, etc., the touch sensor 22 may sense the weight of the food, the change in the weight of the food or a touch of utensils, and the processor 140 may determine whether the user is eating the food and how fast the user is eating the food based on the sensed change of food weight and the sensed touch of utensils.

The first element panel 23 is a panel on the upper area with reference to the display panel 24, and may include a camera capturing food or a user, an ingredient detector which detects ingredients of the food, a salinity sensor, a temperature sensor, a pH sensor sensing pH level of the food, an illumination sensor and a weight sensor which detect an area where the food is placed.

The display panel may display a user's dietary guide including various information to guide the user's diet under the control of the controller 140. The display panel 24 may be implemented as LCD, OLED, etc., and may also be implemented as a transparent display. The embodiment where the display panel 24 is implemented as a transparent display panel will be described with reference to FIGS. 2B and 2C.

Referring to FIGS. 2B and 2C, if the display panel 24 is implemented as a transparent display, the display panel 24 may be realized as a dual display having a structure where transparent display panels are piled up vertically. The dual display panel 24-1, 24-2 is configuration to increase color representation, and may increase visibility of an image displayed on the upper display panel 24-1 as the lower display panel 24-1 blocks light.

For example, the upper display panel 24-1 of the dual display panel.

For example, the upper display panel 24-1 of the dual display panel 24-1, 24-2 may be implemented as a transparent OLED, and the lower display panel 24-2 may be implemented as a transparent LCD. In this case, when no image is displayed, the dual display panel 24-1, 24-2 may maintain the transparent state, but when an image is displayed, the image may be output on the upper display panel 24-1 and a blackish color which blocks light may be displayed on the lower display panel 24-2 so as to change the state of the dual display panel 24-1, 24-2 to an opaque state.

In other words, by dividing the dual display panel 24-1, 24-2 into the display panel 24-1 which outputs an image and the display panel 24-2 which adjusts transparency, an object, etc. may be penetrated and displayed on the rear side of the dual display panel 24-1, 24-2, remedying the drawback of a transparent display panel which has poor color representation.

The second element panel 25 is a panel including elements which are disposed on the rear side of the electronic apparatus 100 with reference to the display panel 24, and on the second element panel 25, various communication elements such as rear camera, acceleration sensor, microphone, speaker, ultrasound sensor, ZigBee communication element, Bluetooth communication element, Wi-Fi communication element, etc. may be disposed. The second element panel 25 may include the processor 140, a battery, etc.

The battery is connected to the display panel 24, and may provide power to the display panel 24. The battery may be charged using a wireless charging method or a solar-light power charging method. The battery may be provided in the form of plate and disposed on the bottom side of the electronic apparatus 100. The battery may be implemented in various forms which may provide power to the display panel 24. The electronic apparatus 100 may receive power wirelessly from an external charging station or a charging pad using one of an electromagnetic induction method and a magnetic resonance method and charge the battery.

In the case of the wireless charging method using magnetic induction, the second element panel 25 may include a first coil which generates various electromagnetic field and a second coil which receives an induced current generated in a charging station, etc., and charging may be performed when the electronic apparatus 100 is placed on a charging station, etc.

In the case of the wireless charging method using resonant magnetic coupling, the second element panel 25 may include a coil which has the same resonance frequency as the coil of the charging station, and charging may be performed even when the second element panel 25 is spaced apart from the charging station.

Meanwhile, in the case where the battery is charged via wire, a charging terminal formed on one side of the electronic apparatus 100 may be combined with a charging terminal provided on a cradle, etc. and thus, charging may be performed.

In the case of the solar-light charging method, a solar-cell panel may be provided on one side of the electronic apparatus 100 to store solar energy.

As illustrated in FIG. 2A, the electronic apparatus 100 according to an embodiment may have a structure which is divided into a central part of the inside of the space where food is placed and a peripheral part which surrounds the central part and is uplifted to be placed higher than the central part. As the peripheral part is uplifted to be higher than the central part, it is possible to prevent food from being out of the electronic apparatus 100.

Meanwhile, the electronic apparatus 100 according to an embodiment may be designed to have a water-repellent coating on the body of the electronic apparatus 100 so that the internal elements of the electronic apparatus 100 cannot be affected by food or water.

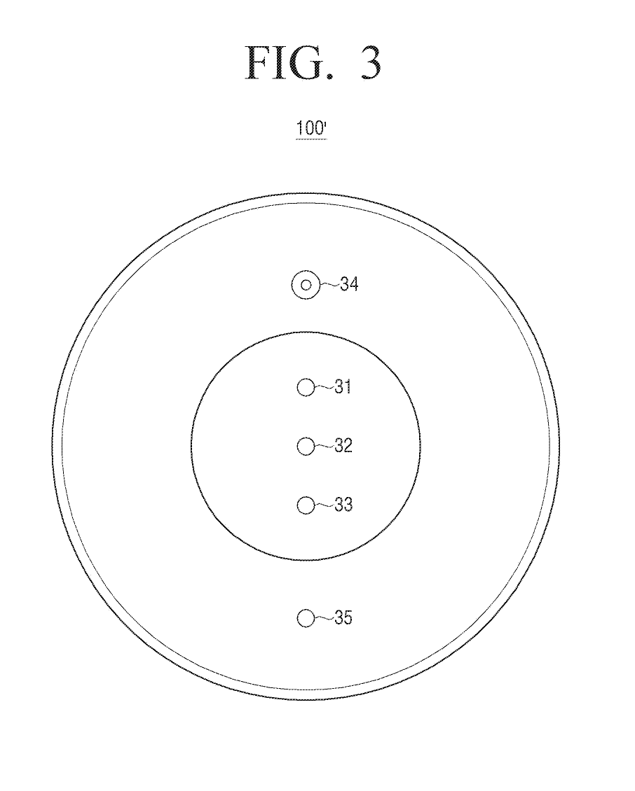

FIG. 3 is a view provided to explain elements included in an inner side of an electronic apparatus according to an embodiment of the present disclosure.

Referring to FIG. 3, elements which can sense characteristics of food contacted, such as a salinity sensor 31, a temperature sensor 32 and a pH sensor 33 of the first element panel 23 may be positioned at the central part of the inside of the electronic apparatus 100′ where food is placed. In addition, a front camera 34 which may capture food of the first element panel 23 or a user, an ingredient detector 35, etc. may be positioned at the peripheral part which surrounds the central part.

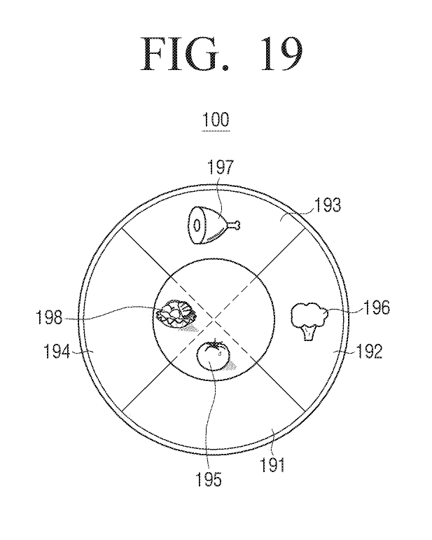

However, the location of each element which is included in the first element panel 23 is not limited to the above embodiment, and the technical feature of an embodiment may also be applied to an embodiment where each element is disposed in various locations of the electronic apparatus 100′. For example, the ingredient detector 35 may be provided at the central part of the inner side of the electronic apparatus 100′. In addition, in an embodiment where the inner side of the electronic apparatus 100′ is divided into a plurality of areas and characteristics of food placed on each of the plurality of areas are sensed respectively, a plurality of ingredient detectors 35 may be provided on each area, which will be described in detail with reference to FIG. 19.

The processor 140 may measure salinity level of food which comes in contact with the central part of the inner side of the electronic apparatus 100′ using the salinity sensor 31. The processor 140 may control to provide a visual feedback which may help diet of a patent with high blood pressure using the measured salinity level. In addition, the processor 140 may measure temperature of an area where food is placed in the electronic apparatus 100 and temperature of the food, etc. using the temperature sensor 32. In addition, the processor 140 may measure pH level of the food using the pH sensor 33 or may inform a user about freshness of the food based on the measured pH level.

The front camera 34 captures food which is placed on the electronic apparatus 100′, and the type of food may be identified based on the food image captured by the front camera 34. In addition, the front camera 34 may capture a user's hand, the size of head, etc. and thus, may identify whether the user is an adult or a child. As a face is recognized through the front camera 34, the user can be identified.

Here, the front camera 34 may be a wide-angle camera or a fisheye camera having a broad angle of view. In particular, in the case of a fisheye camera having an angle which is greater than 180°, even if the front camera 34 is provided on the inner side of the electronic apparatus 100′, the food placed on the electronic apparatus 100′ can be captured.

Meanwhile, a food image captured by a fisheye camera may be calibrated through camera calibration with respect to radial distortion, tangential distortion, etc.

The ingredient detector 35 may include a molecule analyzer which is implemented as a molecule scanner which may read chemical composition of food using a near-infrared spectroscopy. Specifically, the molecule analyzer may emit near-infrared ray and analyze the light which is reflected from the food in order to analyze the nutrients of the food such as fat, sugar, protein, etc., boiled state, decomposition state, etc. In addition, the molecule analyzer may acquire various information such as the ingredients, calories, water content, type of additives, etc. from the analyzed information.

Meanwhile, the electronic apparatus 100′ may include an optical receiver (not illustrated) which may receive calorie information, etc. of the food from an external mobile mole analyzer instead of the ingredient detector 35.

The optical receiver is an element which receives an optical signal and converts it to an electrical signal, and may receive calorie information, etc. using Wi-Fi communication which uses waves of light which is transmitted while LED lamp of an external mobile molecule analyzer, etc. is flickering.

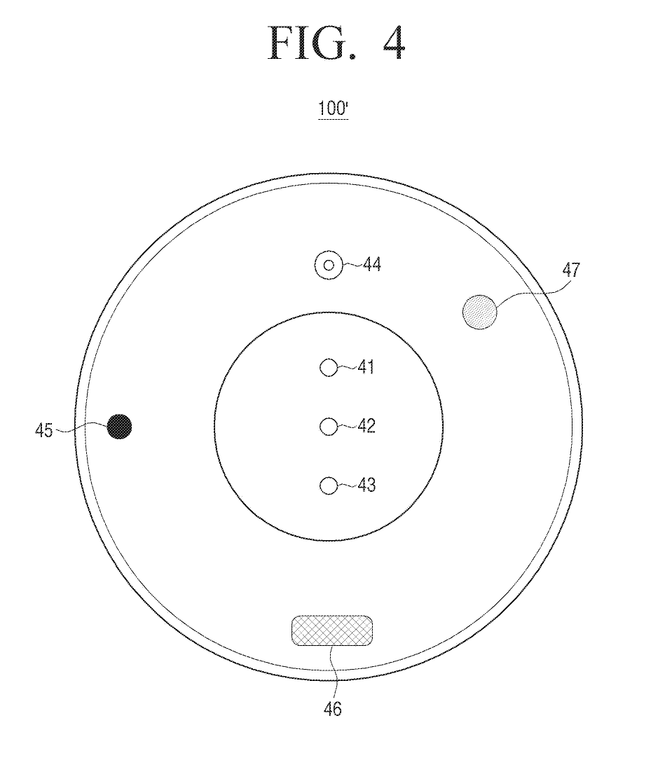

FIG. 4 is a view provided to explain elements included in an external side of an electronic apparatus according to an embodiment of the present disclosure.

Referring to FIG. 4, an acceleration sensor 41, a microphone 42, an ultrasound sensor 43, etc. of the second element panel 25 may be located at the inner central part of the outer side of the electronic apparatus 100′. In addition, a rear camera 44, a communication element 45, a speaker 46, a button 47, etc. may be located at the peripheral part which surrounds the central part.

The processor 140 may measure acceleration and the direction of the acceleration at the time of a movement using the acceleration sensor 41. Specifically, the acceleration sensor 41 outputs a sensing value corresponding to gravity acceleration which changes according the gradient of the electronic apparatus 100′ where the acceleration sensor 41 is attached.

The acceleration sensor 41 may determine a sensing start time regarding the characteristics of the food by sensing the movement of the electronic apparatus 100′. For example, the movement may be sensed at the moment when the electronic apparatus 100′ is picked up by a user to have a meal after being put in a sleep mode which is a low power mode. When the movement is sensed, the electronic apparatus 100′ may recognize that the user starts eating, and may sense the characteristics of the food from when the movement is sensed or after a predetermined time elapses from the time when the movement is sensed.

The microphone 42 identifies a user by recognizing the user's voice. If the user voice which is input through the microphone 42 is converted to an electrical signal, the user corresponding to the unique frequency characteristics of the converted electrical signal may be identified.

The ultrasound sensor 43 measures characteristics related to the hardness of the food, and may measure hardness of the food by measuring material property of the internal tissue such as elastic coefficient, viscosity characteristics, etc. based on acoustic resistance structure and elastic property. The processor 140 may control the display 110 to provide a visual feedback regarding the recommend number of chewing according to the hardness of food which is measured by the ultrasound sensor 43.

The rear camera 44 may sense the color of the table, etc. where the electronic apparatus 100′ is placed. Subsequently, the processor 140 may provide an appetite loss effect by controlling the color displayed on the display 110 to be a complementary color regarding the table color sensed through the rear camera 44. In addition, just like the front camera 34 provided in the inner side, the camera 44 may also capture the user's face, finger, etc. to identify the user.

Meanwhile, the communication element 45 may be provided in the peripheral part of the outer side of the electronic apparatus 100′, and may include at least one of ZigBee communication element, Bluetooth communication element, Wi-Fi communication element, etc.

The ZigBee communication element is an RF sensor to sense the movement of utensils for picking up food, such as spoon, chopsticks, fork, etc., and may trace simple approach, vibration, movement, etc. of the utensils with an RF sensor. To do so, the ZigBee communication element may be implemented as a directional ZigBee communication element. Meanwhile, the ZigBee communication element may be implemented as a plurality of elements and may be provided on both sides of the peripheral part of the inner side of the electronic apparatus 100′.

The Bluetooth communication element and the Wi-Fi communication element are elements to perform communication with an external apparatus, etc. using a Bluetooth method or a Wi-Fi method. By using the Bluetooth communication element and the Wi-Fi communication element, movement information, etc. of utensils of another electronic apparatus may be received, and user identification information, user information, etc. may be received through an external apparatus such as smart phone, tablet PC, wearable device, etc. When communication is performed by Bluetooth, the electronic apparatus 100′ may perform pairing with another electronic apparatus or an external apparatus.

The speaker 46 outputs user's dietary guide through sound. For example, if it is determined that the user does not eat the food which is placed on the electronic apparatus 100′ for a predetermined time by using a weight sensor, notification sound is output through the speaker 46 to induce the user to eat the food.

The button 47 receives various user commands from a user.

For example, a user may press the button 47 to turn on the electronic apparatus 100′, identify the user and perform the operation of displaying the user's dietary guide. The button 47 may be implemented as a plurality of buttons and when the button 47 is implemented as a plurality of buttons, user identification information corresponding to a plurality of users may be allocated to each button. Accordingly, when one of the plurality of buttons is pressed, the electronic apparatus 100′ may identify the user using the user identification information allocated to the corresponding button. In addition, the button 47 may perform a fingerprint recognition function to recognize the user's fingerprint and identify the user.

As shown in the above embodiment, the button 47 may be implemented based on hardware method, but the button 47 may also be implemented based on software method through the display 110.

In addition, the location of each element included in the second element panel 25 is not limited to the above embodiment, and the technical feature of the present disclosure may also be applied to an embodiment where each element is positioned in various locations of the electronic apparatus 100′.

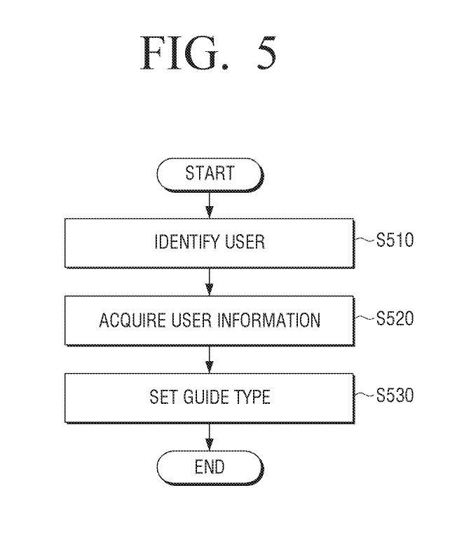

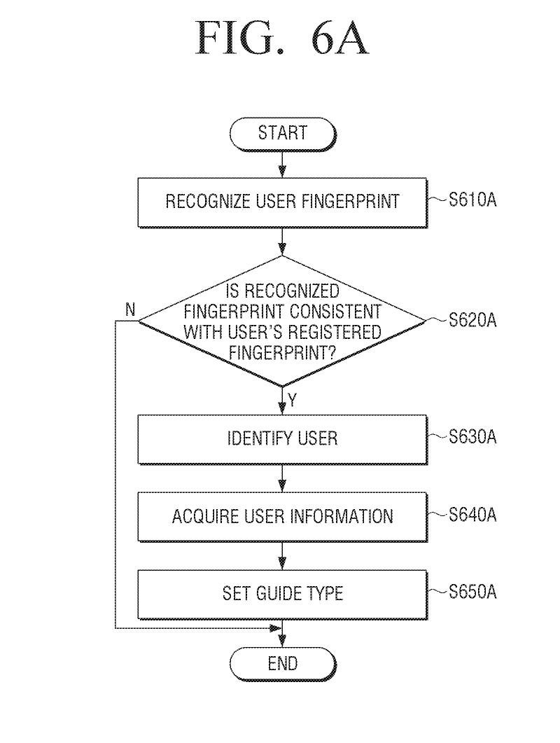

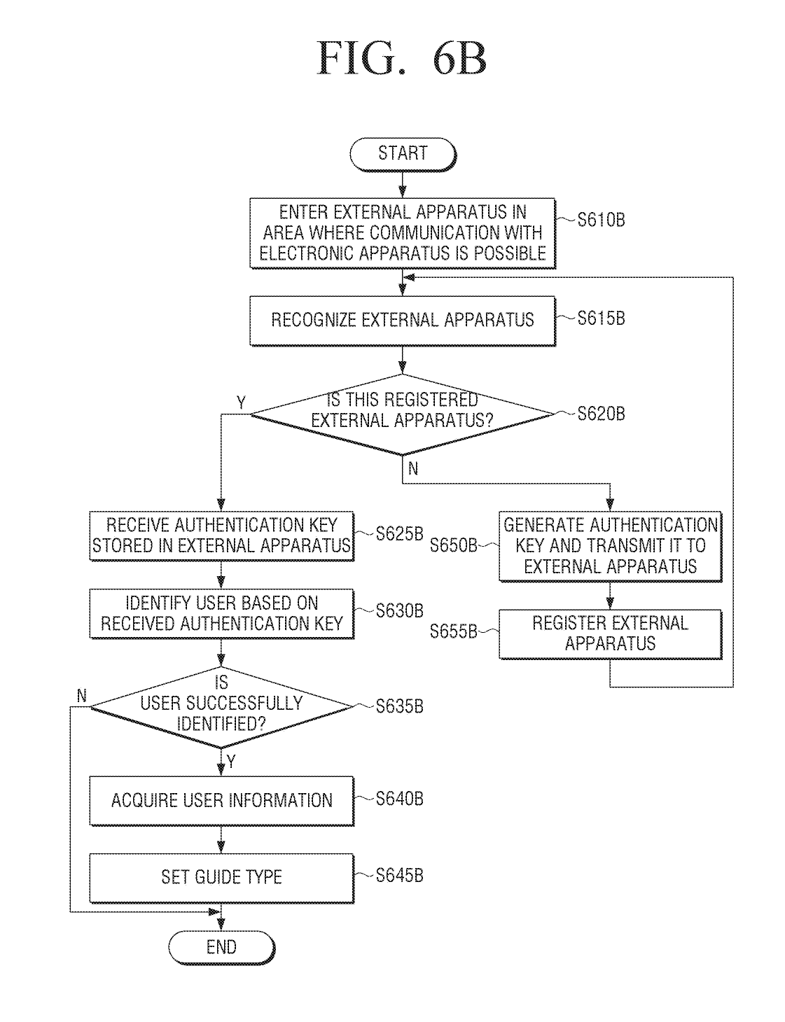

FIGS. 5 and 6A to 6B are flowcharts provided to explain a guide-type determining method according to various embodiments of the present disclosure.

FIG. 5 is a flowchart regarding the method of determining a guide type by the electronic apparatus 100 according to an embodiment of the present disclosure.

First of all, the electronic apparatus 100 identifies a user at operation S510. In this case, user identification may be performed by making a touch input of ID, pin number, etc. through the input unit 120 such as button, touch pad, etc. based on hardware or through an input screen which is displayed based on software on the display 110 implemented as a touch display.

Alternatively, user identification information may be received from an external apparatus which communicates with the electronic apparatus 100, such as a user terminal apparatus, etc. The electronic apparatus 100 may also receive user information regarding the identified user from an external apparatus.

The user identification may be performed through a biometric recognition sensor such as a fingerprint recognition sensor, an iris recognition sensor, a vein recognition sensor, etc. In addition, a user may be identified by recognizing face, the size of hand, the size of head, etc. through a camera, a face recognition sensor, etc., and a user may also be identified by recognizing the user's voice which is input through a microphone through a voice recognition sensor. In this case, the size of the user's hand may be recognized by calculating the coordinates of the part touched on the touch sensor, and the electronic apparatus 100 may determine whether the user is an adult of a child therefrom. In addition, the electronic apparatus 100 may perform communication with an external apparatus that the user is carrying, such as a pre-registered smart phone, a wearable device, various user terminal apparatuses, etc., receive an authentication key from the external apparatus, and identify the user by comparing the received authentication key with a pre-registered authentication key.

Subsequently, when the user is identified, user information regarding the identified user is acquired at operation S520. Here, the user information may include user's body information, user's dietary history information, user's goal setting information, user's food preference information, etc. The user information may be stored in the storage 150, or may be received from an external apparatus or a server which communicates with the electronic apparatus 100.

The electronic apparatus 100 may determine the guide type regarding the user based on the acquired user information at operation S530. Specifically, the electronic apparatus 100 may determine the guide type of the user based on the user's goal setting information, user's body information, etc. of the acquired user information to guide the user to adjust food intake, or may display the user's dietary guide to guide the user not to have unbalanced eating or to control eating speed according to the determined guide type.

The electronic apparatus 100 may determine the guide type according to the user's goal setting information, and may also determine the guide type according to the user's body information, user's dietary history information, etc. In other words, if the user's goal setting information does not exist, the electronic apparatus 100 may determine the guide type based on the user's body information, user's dietary history information, etc.

FIG. 6A is a flowchart regarding the method of determining a guide type according to an embodiment of the present disclosure.

Referring to FIG. 6A, first of all, a user may recognize a fingerprint using a fingerprint recognition sensor provided on one are of the inner side or the outer side of the electronic apparatus 100 at operation S610A. The fingerprint recognition sensor may be realized using a non-optical method using a semiconductor sensor, but may also be realized in an optical method using a scanner. In this case, first of all, the user may perform a fingerprint recognition registration process when the user uses the electronic apparatus 100 for the first time. The fingerprint which is recognized in the fingerprint recognition registration process is processed as a digital signal and stored in the form of biometric recognition templet and subsequently, used to identify a user.

It is determined whether the recognized fingerprint is consistent with the user's fingerprint at operation S620A. The fingerprint recognition sensor reads the user's fingerprint, and if it is determined that the fingerprint is not consistent with the user's pre-registered fingerprint, the user cannot be recognized and thus, the guide type is not set and the fingerprint recognition process is terminated at operation S620A:N. Meanwhile, if the fingerprint is determined to be consistent at operation S620A:Y, the user is identified at operation S630A, and the user information of the identified user is acquired at operation S640A.

Subsequently, the guide type of the user is determined based on the acquired user information at operation S650A.

FIG. 6B is a flowchart regarding the method of determining a guide type according to an embodiment of the present disclosure.

Referring to FIG. 6B, first of all, the electronic apparatus 100 may determine whether an external apparatus enters an area which communication can be performed through the communicator 150. In this case, the external apparatus may include a user terminal apparatus such as a smart phone, a tablet PC, etc., a wearable device, etc.

If an external apparatus enters an area where communication can be performed at operation S610B, the electronic apparatus 100 may recognize the external apparatus at operation S615B, and determines whether the external apparatus is a registered external apparatus at operation S620B. If the external apparatus is not registered at operation S620B, user identification is not performed. However, the electronic apparatus 100 may registered an unregistered external apparatus according to a user command. In this case, an authentication key may be generated and transmitted to the external apparatus at operation S650B, and after going through a registration process in the external apparatus which receives the authentication key, the external apparatus can be registered at operation S655B.

Meanwhile, if the external apparatus is a registered external apparatus at operation S620B:Y, the electronic apparatus 100 may receive an authentication key stored in the external apparatus at operation S625B. In this case, the electronic apparatus 100 may perform pairing with the external apparatus. The electronic apparatus 100 may identify a user based on the authentication key received from the external apparatus at operation S630B, and if the user is successfully identified at operation S635B:Y, may acquire user information regarding the identified user at operation S640B. The electronic apparatus 100 may determine a guide type regarding the user based on the acquired user information at operation S645B.

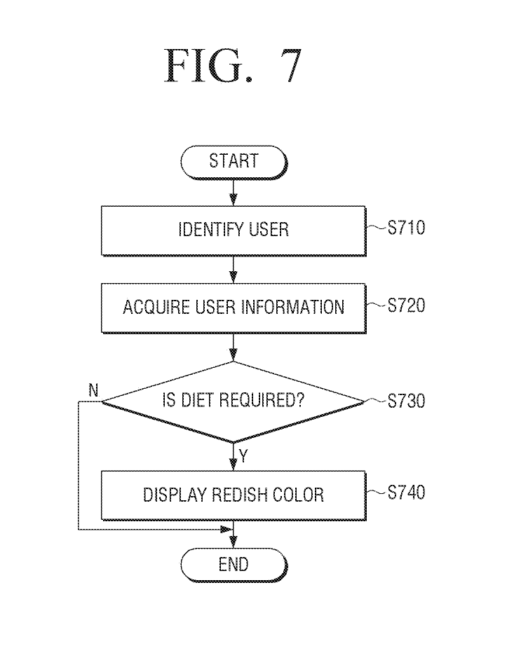

FIG. 7 is a flowchart provided to explain a method of displaying a predetermined color on a display in consideration of a diet purpose according to an embodiment of the present disclosure.

Referring to FIG. 7, first of all, a user is identified at operation S710, and if the user information of the identified user is acquired at operation S720, a guide type regarding the user may be determined based on the acquired user information. For example, the setting information regarding the guide type is diet or it is determined that the user needs to go on a diet based on the user body information, etc. which has been input, the electronic apparatus 100 may determine that the guide type of the user is a food intake guide.

In other words, the electronic apparatus 100 may determine whether the user needs to go on a diet based on the user information at operation S730, and if it is determined that the user needs to be on a diet at operation S730:Y, may control the display 110 to display a reddish color at operation S740. If it is determined that the user does not need to be on a diet at operation S730:N, the electronic apparatus 100 may not change the color displayed on the display 110.

As such, the electronic apparatus 100 may display a reddish color for a user who needs to go on a diet, thereby providing an effect of reducing appetite. On the contrary, the electronic apparatus 100 may also display a yellowish color for a patient with anorexia, who needs to have more food, in order to provide the effect of increasing appetite.

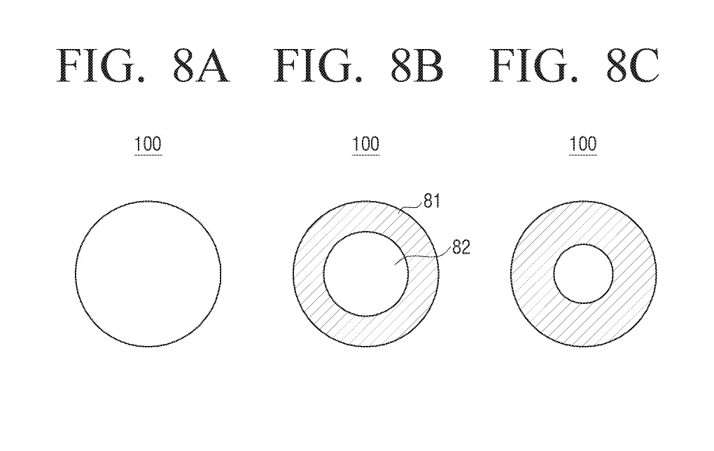

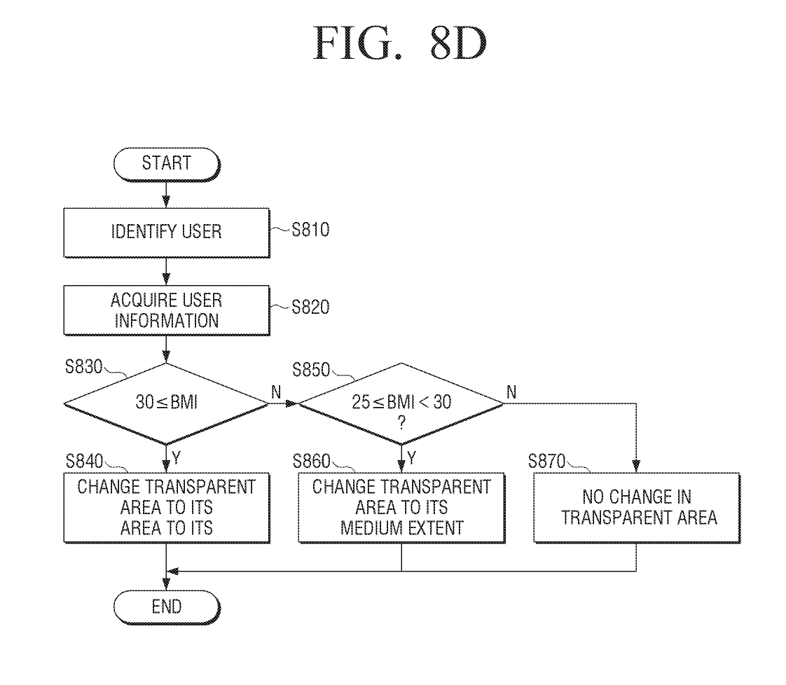

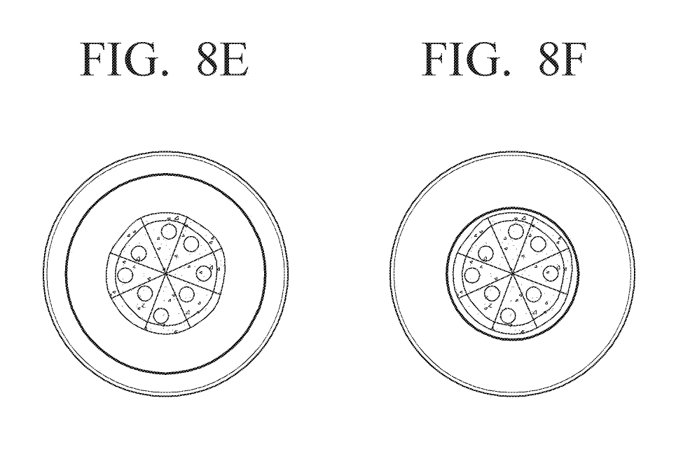

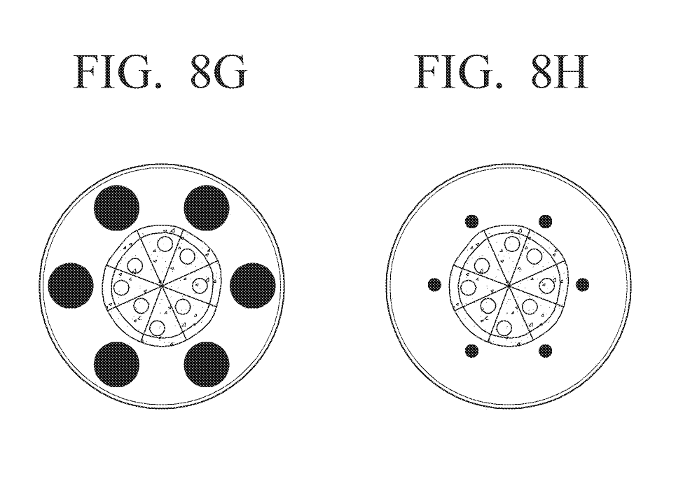

FIGS. 8A to 8H are views provided to explain a method of providing an optical illusion effect with respect to the amount of food in consideration of a diet purpose according to an embodiment of the present disclosure.

FIGS. 8A to 8C are views provided to explain an embodiment of providing an optical illusion effect regarding the amount of food by changing the transparency of an edge area of the electronic apparatus 100 according to an embodiment of the present disclosure.

The display 110 of the electronic apparatus 100 may be implemented as a transparent display as a whole or in part, and the screen including a food intake guide may provide an optical illusion effect where the amount of food placed on the electronic apparatus 100 is recognized differently by displaying an edge area in predetermined transparency. FIG. 8A illustrates the electronic apparatus 100 where the edge area is not displayed transparently, while FIG. 8B illustrates the electronic apparatus 100 where an area 81 of the edge area is displayed transparently. FIG. 8C illustrates the electronic apparatus 100 where the size of the transparent edge area 81 is displayed to become larger.

As illustrated in FIGS. 8A to 8C, the size of the transparent edge area 81 may vary depending on the amount of diet required for each user. The size of the transparent edge area 81 is set such that the more diet a user needs, the larger the size of the transparent edge area 81 as illustrated in FIG. 8C. Accordingly, by making the size of the inner side of the electronic apparatus 100 look smaller, an optical illusion effect of making the amount of food on the electronic apparatus 100 look greater may be provided.

For example, the electronic apparatus 100 may determine how much diet a user needs by using a BMI index based on the user's body information included in the user information and set the size of the transparent edge area. Here, the BMI index is obtained by dividing weight by the square of height and may be used to measure overweight.

In other words, the electronic apparatus 100 may set the size of the transparent edge area to correspond to a user's level of obesity which is determined based on the user's BMI index, etc. For example, if the user's BMI index is more than 30, the electronic apparatus may determine that the user is obese, if the user's index is more than 25 but less than 30, that the user is overweight, and if the user's index is less than 25, that the user has a normal weight, and set the size of the transparent area according to each weight.

FIG. 8D is a flowchart provided to explain the method of proving an illusion effect regarding the amount of food by changing the transparency of the edge area of the electronic apparatus 100 to predetermined transparency according to an embodiment of the present disclosure.

Referring to FIG. 8D, first of all, the electronic apparatus 100 identifies a user at operation S810, and acquires user information of the identified user at operation S820.

Subsequently, the electronic apparatus 100 determines whether the BMI index which is calculated based on the user's body information is more than 30 at operation S830. If it is determined that the BMI index is more than 30 at operation S830:Y, the electronic apparatus 100 determines that the user is obese and may change the size of the transparent edge area to the maximum size at operation S840. If the BMI index is less than 30 at operation S830:N, the electronic apparatus 100 determines whether the BMI index is more than 25 and less than 30 at operation S850. If it is determined that the BMI index is more than 25 and less than 30 at operation S850:Y, the electronic apparatus 100 determines that the user is overweight and may change the size of the transparent edge area to the medium size at operation S860. Meanwhile, if the BMI index is not more than 25 and less than 30 at operation S850:N, the electronic apparatus 100 may determine that the user has normal weight and may not change the size of the transparent area at operation S870.

FIGS. 8E to 8H are views provided to describe an embodiment of providing an optical illusion effect regarding the amount of food placed on the electronic apparatus 100 according to an embodiment of the present disclosure.

Referring to FIGS. 8E and 8F, an optical illusion effect regarding the amount of food may be provided by displaying a looped curve in the form of circle on the inner side of the electronic apparatus 100.

Specifically, as illustrated in FIG. 8E, the electronic apparatus 100 may provide the effect where the amount of food looks smaller by displaying a circle which is larger than the area occupied by the food. Meanwhile, as illustrated in FIG. 8F, the electronic apparatus 100 may provide the effect where the amount of food looks larger by displaying a circle of which size is similar to the area occupied by the food. The embodiment of FIG. 8E may be applied to a patient with lack of appetite, who needs to increase food intake, and the embodiment of FIG. 8F may be applied to a person who is on a diet.

In addition, as illustrated in FIGS. 8G and 8H, the electronic apparatus 100 may provide an optical illusion effect regarding the amount of food by displaying diagrams such as a plurality of large circles, a plurality of small circles, etc. around the food.

FIG. 8G illustrates the embodiment of providing an optical illusion effect where the amount of food looks smaller by displaying a plurality of large circles around the food at predetermined intervals. FIG. 8H illustrates the embodiment of providing an optical illusion effect where the amount of food looks larger by displaying a plurality of circles which are smaller than those of FIG. 8G around the food.

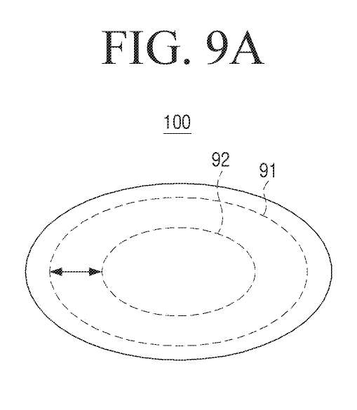

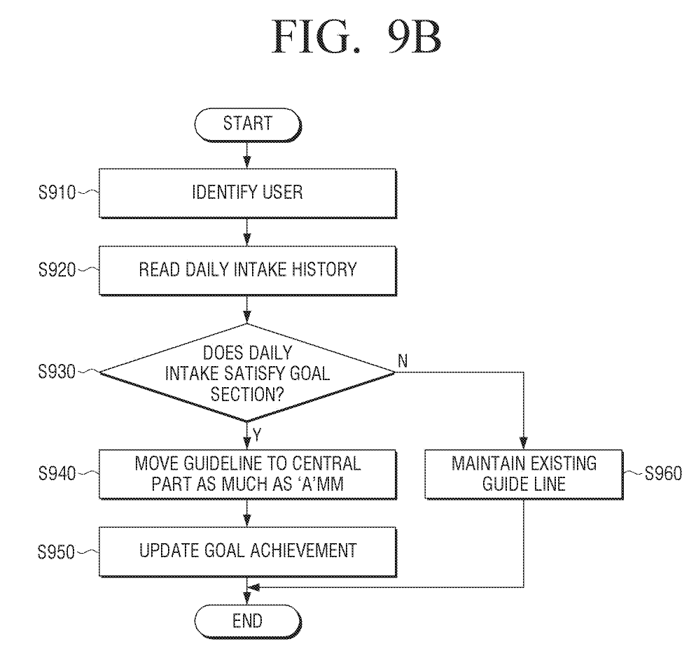

FIGS. 9A and 9B are views provided to explain a method of displaying guidelines corresponding to recommended nutrition intake in consideration of a diet purpose according to an embodiment of the present disclosure.

Referring to FIG. 9A, the electronic apparatus 100 may analyze a user's recommend daily food intake and display guidelines corresponding to the food intake.

Specifically, if food is placed on the electronic apparatus 100, the electronic apparatus 100 may generate guidelines which are displayed using a looped curve in the form of circle, oval, etc. based on the user's body information and user's goal setting information (target weight that the user wishes to lose, etc.). For example, if the user is obese or his or her target weight loss is low based on the user's body information, etc., the amount of recommended food intake is relatively great and thus, the electronic apparatus 100 may display guidelines of a looped curve 91 of a long diameter and guide the user to put food inside the looped curve.

Meanwhile, a minimum guideline diameter 92 corresponding to predetermined minimum recommended intake may be ½ of the maximum guideline diameter corresponding to the maximum recommended intake. Here, the diameter of the maximum guideline may be the diameter of the electronic apparatus 100.

If the user has normal weight and high target weight loss based on the user's body information, etc., the amount of recommended food intake is relatively low and thus, the electronic apparatus 100 may display guidelines of a looped curve of relatively small diameter to be close to the minimum guideline diameter 92.

However, the shape of the guidelines are not limited to the looped curve, and may have various forms such as dotted line, line, color, etc.

FIG. 9B is a flowchart provided to explain the method of changing guidelines according to the purpose of diet according to an embodiment of the present disclosure.

Referring to FIG. 9B, first of all, the electronic apparatus 100 identifies a user at operation S910, acquires user information of the identified user, and read daily intake history from the user information at operation S920.

In this case, the electronic apparatus 100 may set a recommended diet period based on the differences between the current weight input by the user and the standard weight according to the gender and height of the user. According to an embodiment, the recommended diet period is as below.

TABLE 1

| Current weight - Standard weight | |
|---|---|
| (Kg) | Recommended diet period |
| More than 10 Kg | 90 days |
| More than 5 Kg and less than 10 Kg | 60 days |
| Less than 5 Kg | 30 days |

Meanwhile, according to an embodiment, the guide start line diameter according to the user's BMI index may be set as below.

TABLE 2

| BMI section | Guide start line diameter (mm) |
|---|---|
| BMI ≦25 | 80% of diameter of inner side |
| 25 < BMI ≦ 30 | 70% of diameter of inner side |
| 30 < BMI | 60% of diameter of inner side |

According to an embodiment, the electronic apparatus 100 may set the value of dividing the difference between the diameter 91 of the guide start line according to the section to which the user's BMI index belong and the minimum guideline diameter 92 corresponding to the minimum recommended intake which is predetermined in the electronic apparatus 100 by a recommended diet period ((start diameter−minimum diameter/days) as daily amount of change of guideline, ‘a’ mm.

If it is determined that the user's food intake for a predetermined period satisfies the target section, the electronic apparatus 100 may decrease the user's recommended intake gradually and accordingly, the guideline may be moved to the central part to reduce the diameter. Specifically, the electronic apparatus 100 may determine whether the user has eaten food according to the guideline at operation S930. For example, if the user puts food within a certain error range of the guideline displayed on the electronic apparatus 100 for a day at operation S930:Y, the electronic apparatus 100 determines that the user has eaten food in accordance with the target amount and may move the guideline displayed on the electronic apparatus 100 as much as ‘a’ mm towards the central part at operation S940.

According to an embodiment, it is possible to determine whether the user puts food within a certain error range of the guideline displayed on the electronic apparatus 100 for three days at once, and if it is determined that the user has eaten food as much as the target amount, the electronic apparatus 100 may move the displayed guideline towards the central part as much as ‘3a’ mm which is three times ‘a’ mm.

Meanwhile, if the user puts food beyond a certain error range of the guideline displayed on the electronic apparatus 100 at operation S930:N, the existing guideline may be maintained without being moved to the central part at operation S960.

In this case, the electronic apparatus 100 may determine whether the user puts food faithfully following the guideline by using an illusion sensor or a weight sensor which are provided densely one the entire area of the inner side of the electronic apparatus 100. Even if the user puts food within a certain error range faithfully following the guideline, the electronic apparatus 100 may sense the weight of the food placed on the electronic apparatus 100 using a weight sensor provided on the electronic apparatus 100, and if it is determined that the user has eaten more than a predetermined weight of food, the electronic apparatus 100 may also maintain the guideline without moving the guideline towards the central part at operation S960.

If the guideline is moved towards the central part as much as ‘a’ mm, information regarding the move of the guideline is updated, and it is determined whether the diameter of the moved guideline is greater than the minimum guideline diameter 92 corresponding to the minimum recommended intake. If the diameter of the moved guideline is greater than the minimum guideline diameter 92, the process of determining whether the user puts food faithfully following the guideline may be performed repeatedly.

If the diameter of the moved guide line is equal to or smaller than the minimum guideline, that means the user achieve the goal of having food according to the recommended food intake for a predetermined period. Such information may be updated and the guideline display is finished at operation S950.

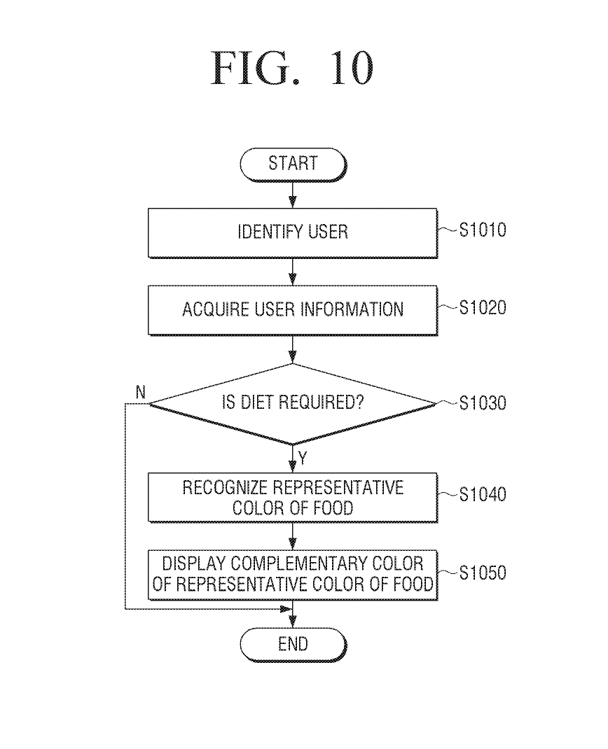

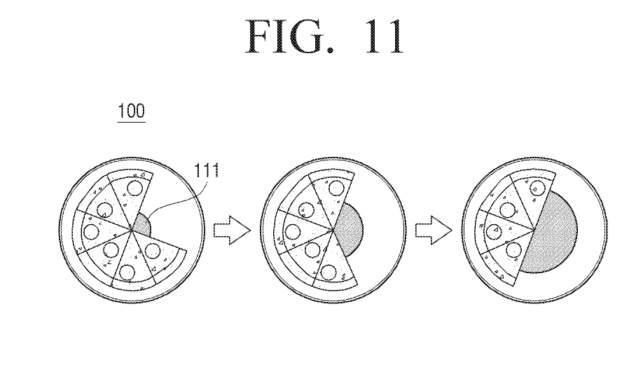

FIGS. 10 and 11 are views provided to explain a method of changing colors displayed on a display in consideration of a diet purpose according to an embodiment of the present disclosure.

FIG. 10 is a flowchart provided to explain the method of changing colors displayed on the display in consideration of a diet purpose according to an embodiment of the present disclosure.

Referring to FIG. 10, first of all, a user is identified at operation S1010, and if user information of the identified user is acquired at operation S1020, a guide type of the user may be determined based on the acquired user information. For example, if the guide type set by the user is a food intake guide or if it is determined that the user is obese based on the user's body information, the electronic apparatus 100 may determine that the user needs to go on a diet and accordingly, may determine that the guide type of the user is a food intake guide.

The electronic apparatus 100 determines whether the user needs to go on a diet based on the user information at operation S1030, and if the user needs to go on a diet at operation S1030:Y, recognizes the representative color of the food using a front camera or a red, green, blue (RGB) sensor provided on the first element panel 23 at operation S1040. In this case, the representative color refers to the main color of the food based on the RGB color information of the food which is recognized through the front camera or the RGB sensor. The electronic apparatus 100 classifies the recognized colors using cluster algorithm, etc. and may recognize the color with the highest pixel accumulation from among the recognized colors as the representative color of the food.

Subsequently, when the representative color of the food is recognized, the electronic apparatus 100 may control the display 110 to display a complementary color of the recognized representative color of the food on the entire or a partial area of the display 110 at operation S1050. This is based on a research result (The Journal of Consumer Research, Cornell University & Georgia Institute of Technology) which shows that when the color of the dish is similar to the color of the food therein, it visually compromises a person's decision regarding the amount of the food and thus, the person may put more food on the dish, ending up eating more food.

Accordingly, if it is determined that the user needs to go on a diet, the electronic apparatus 100 controls to display a complementary color which provides stark contrast to the color of the representative color of the food to guide the user put less amount of food unconsciously, thereby having less food.

FIG. 11 is a view provided to explain the method of changing colors displayed on the display in consideration of a diet purpose according to an embodiment of the present disclosure.

Referring to FIG. 11, the electronic apparatus 100 may determine the user's intake of food placed on the electronic apparatus 100, and as the intake increases, may display the size of a circle 111 in a reddish color to become bigger from the central part gradually. This is to restrain the user's appetite unconsciously by changing the color of the inner side of the electronic apparatus 100 to a reddish color and displaying the intake intuitively at the same time.

In this case, the electronic apparatus 100 may sense the decreasing amount of food using at least one of a weight sensor and an illumination sensor provided on the first element panel 23 and accordingly, may determine the user's food intake.

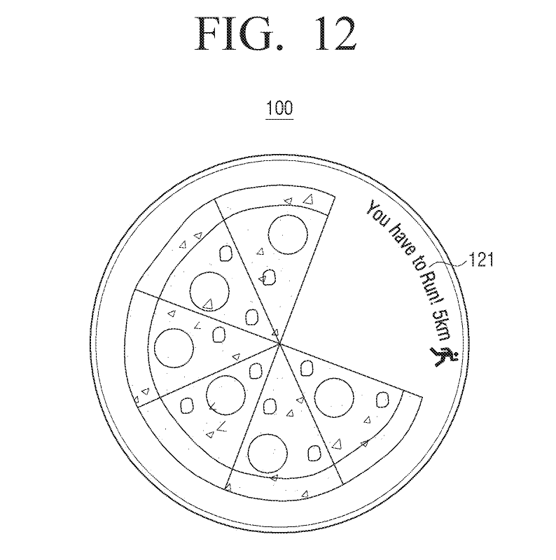

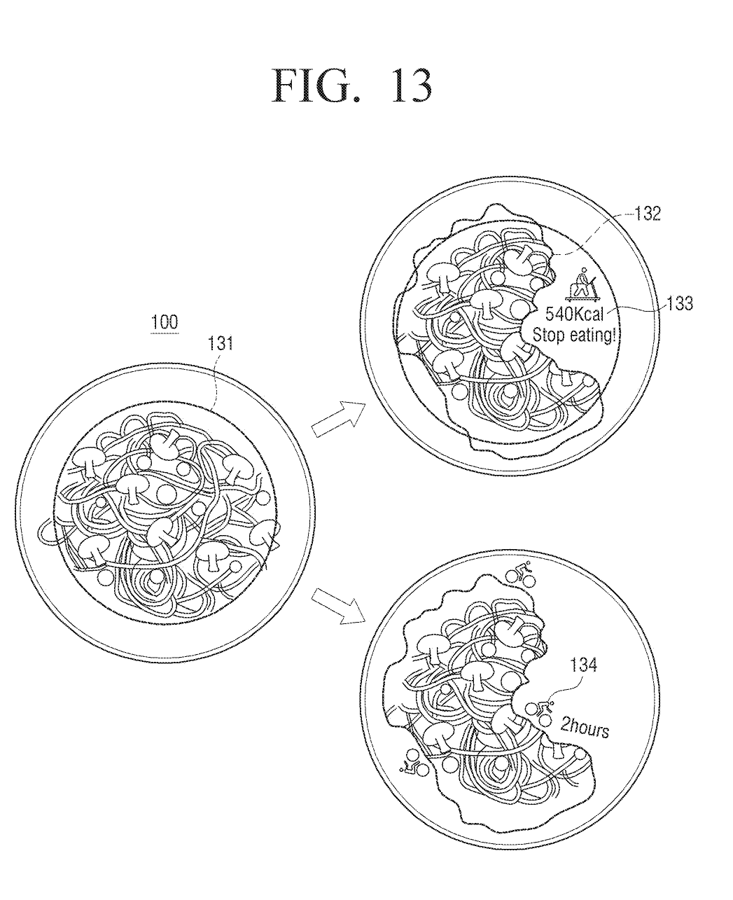

FIGS. 12 to 13 are views provided to explain a method of providing information regarding calorie in consideration of a diet purpose according to an embodiment of the present disclosure.

FIG. 12 is a view provided to explain the method of displaying calories of food which has been consumed in consideration of a diet purpose according to an embodiment of the present disclosure.

Referring to FIG. 12, the electronic apparatus 100 may determine the user's food intake and control to display the amount of exercise which is required to burn the calories of the consumed food to raise awareness to the user.

Specifically, the electronic apparatus 100 may calculate the calories of food placed on the electronic apparatus 100 using at least one of an ingredient detector, a weight sensor and a camera sensor of the first element panel 23, and may calculate the user's food intake and corresponding calories using at least one of an illumination sensor and a weight sensor.

For example, the electronic apparatus 100 may acquire information regarding the weight of consumed food by measuring the decreasing pressure on the food placed on the electronic apparatus 100 using a resistive sensor. In addition, the electronic apparatus 100 may identify the type of food by analyzing the calories of the food through the ingredient detector 35 or capturing the food through the front camera, and acquire calorie information per unit weight regarding the identified food using a server or an external apparatus such as a smart phone, a tablet PC and a wearable device.

Accordingly, as illustrated in the embodiment of FIG. 12, the electronic apparatus 100 may display the minimum exercise information 121 which is required to burn the corresponding calorie based on the calorie information according to the consumed amount of food.

FIG. 13 is a view provided to explain the method of displaying information regarding the calories of consumed food in consideration of a diet purpose according to an embodiment of the present disclosure.

Referring to FIG. 13, the electronic apparatus 100 may detect the area where food is placed on the electronic apparatus 100 and display an outer line 131, 132 according to the outer line of the detected area. Specifically, the electronic apparatus 100 may detect an area which is covered by food, that is, the area where the food is placed based on an illumination value sensed by illumination sensors which are evenly distributed on the entire area of the first element panel 23. As the illumination of the area where the food is placed is lower than the area where the food is not placed, the electronic apparatus 100 may detect the area where the food is placed by detecting the area with low illumination using an illumination sensor and displaying border lines 131, 132 along the outer line of the detected area. In addition, the area where the food is placed may be detected using a weight sensor.

Referring to FIG. 13, the electronic apparatus 100 may display calorie 133 of the food consumed by the user and a message for raising awareness, such as “Stop eating!” on the area which is not covered by the food, detected using an illumination sensor.

In addition, referring to FIG. 13, the electronic apparatus 100 may increase user's interest and raise awareness by displaying an image of a person who is riding a bicycle along the outer line 134 of the area where the food is placed, and may display information regarding minimum amount of exercise which is required to burn the consumed calories.

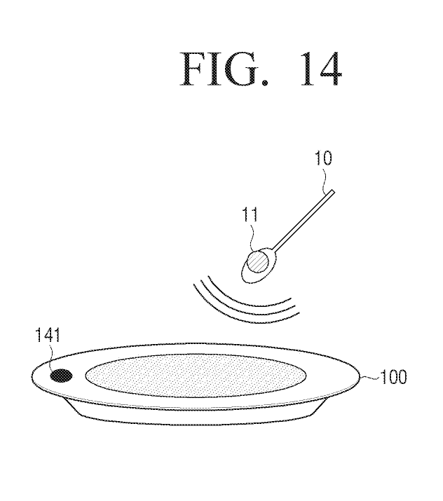

FIGS. 14 to 16 are views provided to explain a method of sensing a movement of utensils linked to an electronic apparatus according to an embodiment of the present disclosure.

Referring to FIG. 14, the electronic apparatus 100 according to an embodiment may sense a movement of utensils 10 for picking up food through the communicator 150. Specifically, the communicator 150 may include at least one of a ZigBee communication element, a Bluetooth communication element and a Wi-Fi communication element, and may also include various communication elements according to an RF communication method to sense a movement of the utensils 10. In this case, the utensils 10 should also include a communication element according to the same communication method as the communication element provided on the electronic apparatus 100. Here, only the embodiment of sensing the utensils 10 using a Bluetooth communication element 141 using BLE communication which is a near field data communication method from among various communication methods will be described.

The electronic apparatus 100 may sense a movement of the utensils 10 for picking up food, such as spoon, chopsticks, fork, etc. through the Bluetooth communication element 141. In this case, the utensils 10 for picking up food should also include a Bluetooth communication method 11 using the same communication method as the electronic apparatus 100.

The electronic apparatus 100 may receive ID and a received signal strength indication or RSSI) value of the utensils 10 from the utensils 10 using the Bluetooth communication element 141 to sense a series of movements of the utensils 10. Specifically, the electronic apparatus 100 may measure an RSSI value from the utensils 10 to sense a movement of the utensils 10. For example, the electronic apparatus 100 may receive an RSSI value from the utensils 10, determine whether the utensils 10 approach from the received RSSI value, and generate information regarding the eating speed, the food intake, etc. Meanwhile, if the utensils 10 are realized as a device which may sense their movement and generate movement information (smart fork, etc.), the electronic apparatus 100 may receive the movement information generated from the utensils 10 directly from the utensils 10.

In addition, the electronic apparatus 100 may sense vibration of the utensils 10 and generate information regarding abnormality or changes in the user's body. In addition, the electronic apparatus 100 may sense the approach order of the utensils 10 and trace the intake course, intake order, etc. in association with another electronic apparatus through communication. Accordingly, the electronic apparatus 100 may generate information regarding the eating habit of the user such as unbalanced eating and provide an unbalanced diet guide to improve unbalanced eating. In addition, the electronic apparatus 100 may sense a specific operation of the utensils 10 such as rummaging, etc. in the electronic apparatus 100, generate information regarding inattentive eating habit of a child, etc., and provide a guide to improve inattentive eating.

In addition, the electronic apparatus 100 may sense at least one of the number of approaches per hour and the change in the food weight to measure the eating speed. If the measured eating speed of the user is faster than a reference speed, a message such as “Eat slowly” may be displayed, or music or notification sound which provides the effect of slowing down the eating speed may be provided through a speaker.

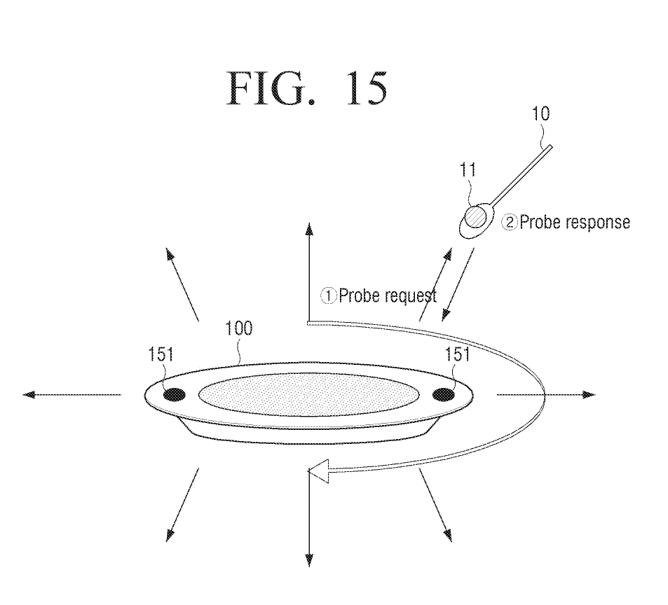

FIG. 15 is a view provided to explain the method of sensing a movement of the utensils 10 linked to an electronic apparatus according to an embodiment of the present disclosure.

In this embodiment, the method of sensing a movement of the utensils 10 using a directional Wi-Fi communication element which performs communication with the utensils 10 will be described.

Referring to FIG. 15, a directional Wi-Fi communication element 151 of the electronic apparatus 100 may transmit a probe request signal (\textcircled{1}) in a clockwise direction or in a counterclockwise direction periodically, and when the utensils 10 which has a directional Wi-Fi communication element 11 just like the electronic apparatus 100 receives the probe request signal, the utensils 10 may transmit a probe response signal (\textcircled{2}) with respect to the electronic apparatus 100. Accordingly, the electronic apparatus 100 may sense that the utensils 10 approaches in a direction where the probe response signal is received.

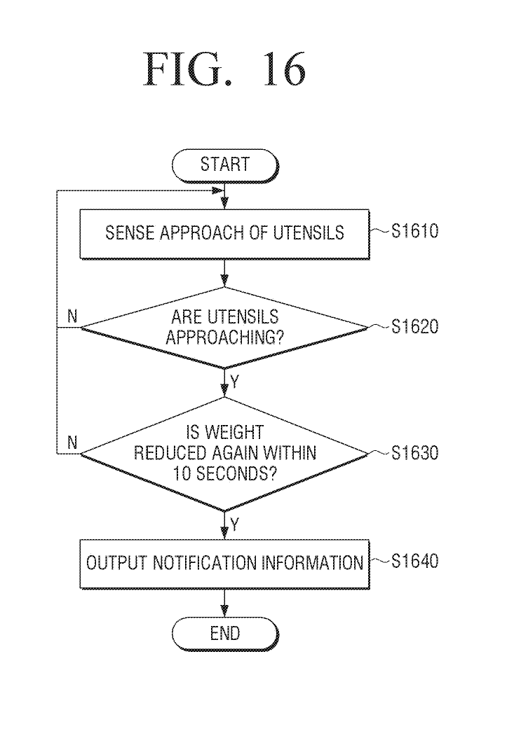

FIG. 16 is a flowchart provided to explain the method of guiding a user to control the eating speed as an electronic apparatus senses an approach of utensils according to an embodiment of the present disclosure.

Referring to FIG. 16, first of all, the electronic apparatus 100 measures an RSSI value regarding the utensils 10 through communication with the utensils 10 for picking up food to sense an approach of the utensils at operation S1610. In this case, the electronic apparatus 100 determines whether the utensils 10 approach to the electronic apparatus 100 within a predetermined distance at operation S1620, and if the utensils 10 approach within the predetermined distance at operation S1620:Y, the electronic apparatus 100 may sense the change in the weight of the food placed on the electronic apparatus 100 using a weight sensor.

In this case, the electronic apparatus 100 determines whether the weight of the food placed on the electronic apparatus 100 is reduced again within ten seconds after the food weight is reduced at operation S1630. If the food weight is reduced again within ten seconds at operation S1630:Y, the electronic apparatus 100 determines that the user is eating the food at the intervals of less than ten seconds and may control to output notification information, etc. in order to guide the user to slow down the eating speed at operation S1640.

In other words, if the user's eating speed is faster than a predetermined standard, the electronic apparatus 100 may provide a visual feedback to guide the user to control the eating speed. In addition, the electronic apparatus 100 may also output notification sound through a speaker to provide an auditory feedback.

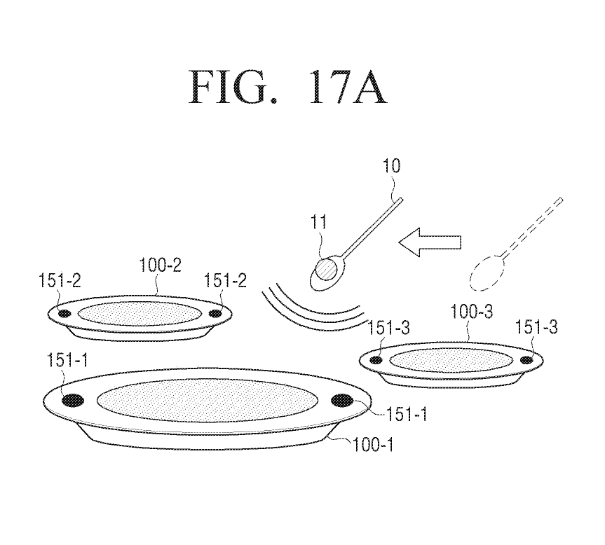

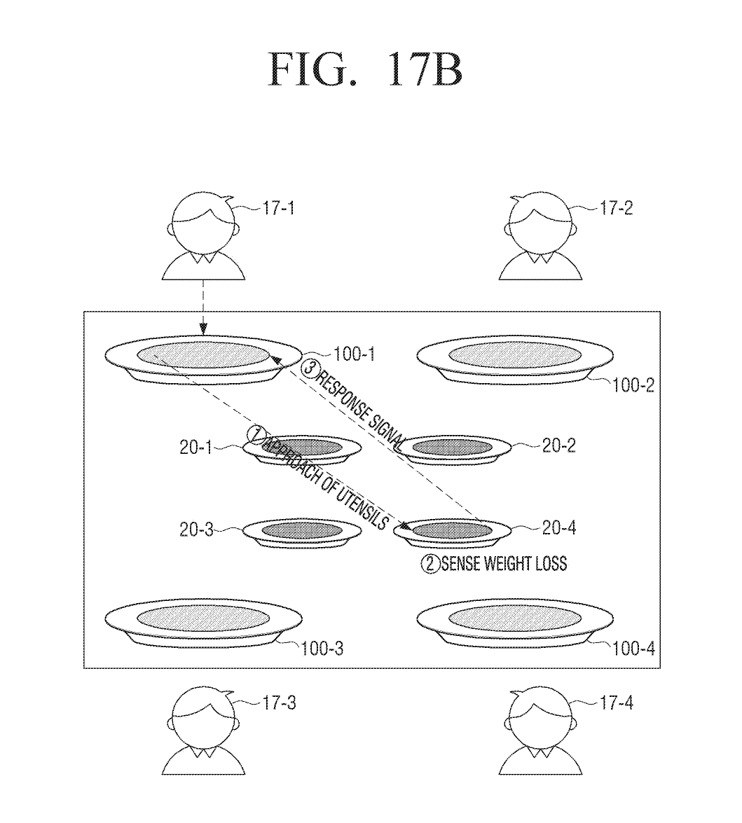

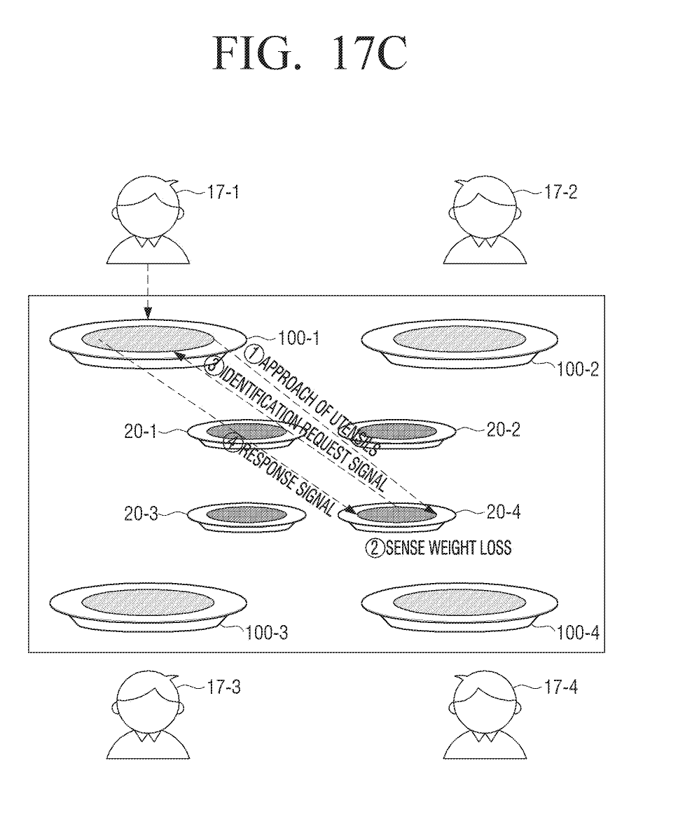

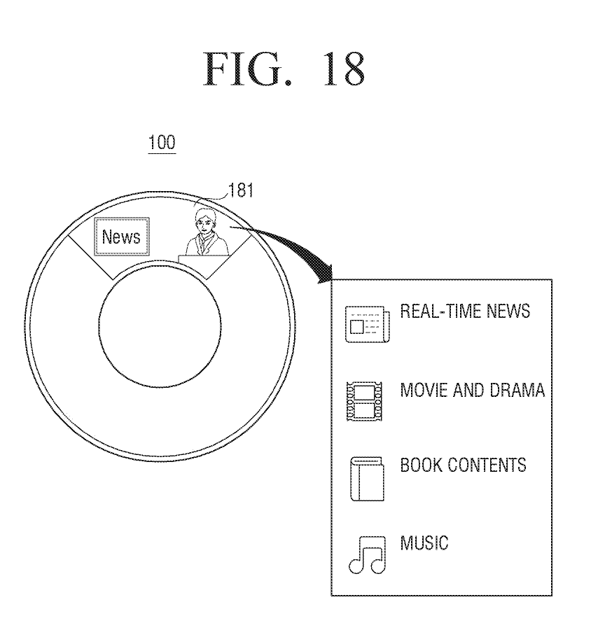

FIGS. 17A to 17C are views provided to explain a method of sensing a movement of utensils linked to a plurality of electronic apparatuses according to an embodiment of the present disclosure.

If different types of food are placed on a plurality of electronic apparatuses 100-1, 100-2, 100-3, each of the plurality of electronic apparatuses 100-1, 100-2, 100-3 may detect ingredients of the food and display the food in different colors according to the ingredients to guide a user to eat in a balanced manner unconsciously.

Meanwhile, referring to FIG. 17A, the plurality of electronic apparatuses 100-1, 100-2, 100-3 which are linked to one another may sense and trace a movement of the utensils 10. If different types of food are placed on a plurality of electronic apparatuses 100-1, 100-2, 100-3, an audiovisual feedback may be provided by the electronic apparatus including the food the user has eaten the least amount in order to guide the user to have nutrients in a balanced manner.

Specifically, through each communication element 151-1, 151-2, 151-3 provided on each electronic apparatus 100-1, 100-2, 100-3, a movement of the utensils 10 having the communication element 11 following the same communication method as each electronic apparatus 100-1, 100-2, 100-3 may be sensed, and an RSSI regarding the utensils 10 may be measured on each electronic apparatus 100-1, 100-2, 100-3 to sense an approach of the utensils 10. In addition, the electronic apparatus which senses the approach of the utensils 10 may count the number of food intake using a weight sensor, and each of the electronic apparatuses 100-1, 100-2, 100-3 may share information regarding the number of food intake.

Accordingly, the electronic apparatus with the least food intake may provide an audiovisual feedback, and each of the electronic apparatuses 100-1, 100-2, 100-3 may analyze the corresponding user's eating habit and utilize the information regarding the analyzed eating habit to guide the user for his or her future meals.

FIG. 17B is a view provided to explain the method where an electronic apparatus senses a movement of utensils including user information according to an embodiment of the present disclosure.

Referring to FIG. 17B, a plurality of users 17-1˜17-4 may have meals using exclusive electronic apparatuses 100-1˜100-4 and common electronic apparatuses 20-1˜20-4. In this case, the utensils that each of the plurality of users 17-1˜17-4 uses may be exclusive food utensils including the corresponding user identification information.

The fourth common electronic apparatus 20-4 may sense an approach of the food utensils using an RSSI value (\textcircled{1}), and if it is determined that the utensils approach within a predetermined distance, may determine whether the weight of the food placed on the fourth electronic apparatus 20-4 has been reduced within a predetermined period (\textcircled{2}). If the weight of the food is reduced, the fourth common electronic apparatus 20-4 may determine that the user 17-1 of the corresponding food utensils has eaten the food, and may transmit an response signal to the first exclusive electronic apparatus 100-1 of the corresponding user (\textcircled{3}). In this case, each of the common electronic apparatus 20-1˜20-4 may transmit a response signal to the corresponding user 17-1 based on the user identification information included in the food utensils. Here, the information regarding the food placed on each of the common electronic apparatuses 20-1˜20-4 may be included in the response signal or may be transmitted to each of the exclusive electronic apparatuses 100-1˜100-4 in advance.

Meanwhile, when the first exclusive electronic apparatus 100-1 receives the response signal, the dietary history of the corresponding user 17-1 may be stored, and based on the response signal, an audiovisual feedback informing whether the user has an unbalanced diet may be provided. For example, the first exclusive electronic apparatus 100-1 may count the number of response signals received from each of the common electronic apparatuses 20-1˜20-4, and if the number of the response signals received from the second common electronic apparatus 20-2 is the lowest, may determine that the user 17-1 has an unbalanced eating habit with respect to the food placed on the second command electronic apparatus 20-2 and display information for this unbalanced eating habit.

In addition, the first exclusive electronic apparatus 100-1 may transmit a specific signal based on the number of counted response signals with respect to the second common electronic apparatus 20-2, and the second common electronic apparatus 20-2 which receives the corresponding signal may output a notification signal through a speaker or provide an audiovisual feedback by flickering the display 110, etc.

FIG. 17C is a view provided to explain the method where an electronic apparatus senses a movement of food utensils which do not include user identification information according to an embodiment of the present disclosure.

Referring to FIG. 17C, it is assumed that the user 17-1 of the first exclusive electronic apparatus 100-1 eats food placed on the fourth common electronic apparatus 20-4 using food utensils which do not include user identification information. In this case, each of the exclusive electronic apparatuses 100-1˜100-4 and each of the common electronic apparatuses 20-1˜20-4 may include a communication element having a directional antenna such as a ZigBee communication element, a direction Wi-Fi communication element, etc. In this case, the fourth common electronic apparatus 20-4 may sense an approach of the food utensil using an RSSI value (\textcircled{1}), and if it is determined that the food utensils approach within a predetermined distance, may sense whether the weight of the food placed on the fourth common electronic apparatus 20-4 may be reduced within a predetermined period (\textcircled{2}).

If the weight of the food is reduced, the fourth common electronic apparatus 20-4 may transmit an identification request signal request user information in a direction where the food utensils are sensed by a directional antenna (\textcircled{3}). Accordingly, the first exclusive electronic apparatus 100-1 which receives the identification request signal may transmit a response signal including the user identification information to the fourth common electronic apparatus 20-4 (\textcircled{4}).

Meanwhile, the first exclusive electronic apparatus 100-1 which transmits the response signal may store the dietary history of the corresponding user, and count the number of response signals transmitted so as to provide an audiovisual feedback informing the common electronic apparatus with the lowest number of response signal transmission. In addition, the first exclusive electronic apparatus 100-1 may transmit a specific signal based on the number of response signal transmission with respect to the common electronic apparatus with the lowest number of response signal transmission and the common electronic apparatus which receives the corresponding signal may provide an audiovisual feedback.

FIG. 18 is a view provided to explain a method of displaying various contents by an electronic apparatus according to an embodiment of the present disclosure.

Referring to FIG. 18, various contents 181 may be displayed on one area of the peripheral part of the inner side of the electronic apparatus 100. Specifically, various contents such as real-time news video, movie, drama, book contents, music play screen, etc. may be displayed on the corresponding area, and a content selection menu for selecting a content, an icon, etc. may be provided. In addition, the electronic apparatus 100 may be linked to a user terminal apparatus such as a smart phone to display an image, a text message, etc. stored in the user terminal apparatus.

The above embodiment is to guide the user to chew food slowly while watching contents, and may provide an environment where the user may enjoy eating in a relaxed manner by displaying contents according to the user's selection. In this case, the electronic apparatus 100 may be connected to a server via Internet and play the corresponding contents by streaming move, drama, etc. in real time.

In addition, the electronic apparatus 100 may communicate with a user terminal apparatus such as a smart phone, a tablet PC, etc. and share a screen with the user terminal apparatus by mirroring the screen displayed on the user terminal apparatus and the opposite may also be applied.

Meanwhile, the electronic apparatus 100 may sense a user's location using a camera provided on the inner side or outer side, and play contents towards the user in an area corresponding to a direction opposite to the direction where the user is located. If the user performs the operation of lifting the electronic apparatus 100 after finishing eating, the electronic apparatus 100 may sense the operation using an acceleration sensor or a touch sensor, and may pause the displayed content or stop playing the content.

FIG. 19 is a view provided to explain a method of recommending food by an electronic apparatus according to an embodiment of the present disclosure.

Referring to FIG. 19, the inner side of the electronic apparatus 100 may be divided into a plurality of areas 191˜194, and each of the plurality of divided areas may sense the food placed on each area, respectively. If food is placed on the central part of an area from among the plurality of areas, the corresponding area may analyze the ingredients of the food and display information regarding recommended food on each of the peripheral part of the remaining area from among the plurality of areas based on the analyzed ingredient of the food.

For example, if a predetermined event occurs as illustrated in FIG. 19, the inner side of the electronic apparatus 100 may be divided into a first area 191, a second area 192, a third area 193 and a fourth area 194 according to a user's selection. In this case, at least one ingredient detector 35 may be included in the central part or the peripheral part of each area. Here, the predetermined event may include a user input through a button or a touch sensor, sensing a specific operation by an acceleration sensor, sensing food being placed using a weight sensor or an illumination sensor, etc.

Meanwhile, if a user puts a tomato 195 at the central part of the first area 191 and a muffin 198 at the central part of the fourth area 194, the characteristics of the food placed on the first area 191 and the fourth area 194 may be sensed, respectively. The electronic apparatus 100 may determine the type and amount of the nutrients included in the tomato 195 and the muffin 198 based on the sensed food characteristics data, and may determine the nutrients which lack in the tomato 195 and the muffin 198 and food including the corresponding nutrients relatively more than other food. In this case, the electronic apparatus 100 may include at least one ingredient detector 35 for sensing characteristics of food in each area 191˜194.

Accordingly, the electronic apparatus 100 may display an image of parsley 196 and an image of meat 197 on the peripheral part of the second area 192 and the third area 193, respectively, to guide the user to put food corresponding to the displayed image on the central part of the corresponding area.

Meanwhile, according to an embodiment, the electronic apparatus 100 may capture food placed on each area using a front camera and perform an image search through a server based on the captured food image. Accordingly, if the food placed on each area is determined, the electronic apparatus 100 may determine the category of the determined food based on predetermined categories (meat, vegetable, fruit, bread, etc.) with respect to the type of food, and display images of food in other categories on the other empty areas.

However, in FIG. 19, the peripheral part of the electronic apparatus 100 is divided into four areas for convenience of explanation, but this is only an example. The peripheral part may be divided into less than four areas or other various areas such as five areas, six areas, etc. In addition, the central part instead of the peripheral part may be divided into a plurality of areas as described above.

According to an embodiment, when a user eats food at a buffet, etc., the electronic apparatus 100 may allow the user to put various foods on a plurality of divided areas to prevent an unbalanced eating or imbalance of nutrient intake.

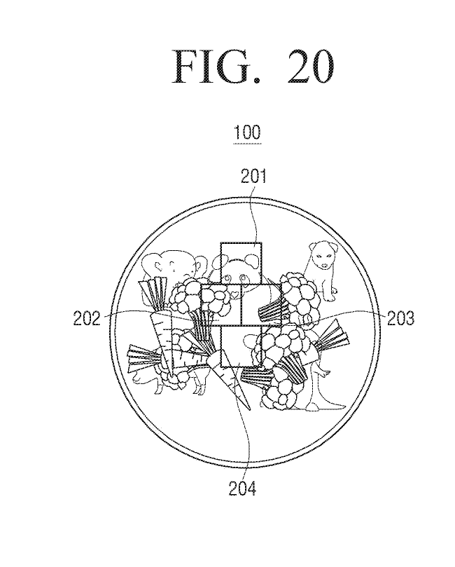

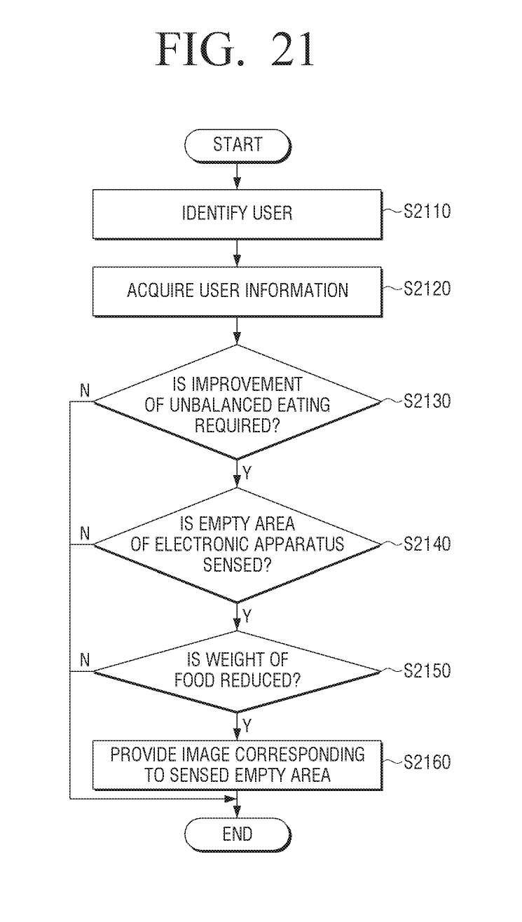

FIGS. 20 and 21 are views provided to explain a method of guiding a user to improve an unbalanced diet by causing interest through a display according to an embodiment of the present disclosure.

FIG. 20 illustrates an embodiment where if the guide type of a user is an unbalance diet guide to improve an unbalanced diet, the electronic apparatus 100 detects an empty area which is not covered by food using a weight sensor, an illumination sensor, a proximity sensor, etc., and displays a corresponding image on the empty area to cause interest for children.

Specifically, referring to FIG. 20, the electronic apparatus 100 may select an image to be displayed on the inner side. The image to be displayed may be selected by a user or may selected randomly in advance. The electronic apparatus 100 may detect an empty area which is not covered by food using an illumination sensor and display image pieces 201˜204 corresponding to the empty area from among selected images. In this case, the electronic apparatus 100 may determine whether the total weight of the food placed on the electronic apparatus 100 is reduced using a weight sensor, and may display the corresponding image pieces 201˜204 only when the total weight is reduced. This is to prevent displaying the image pieces 201˜204 on the corresponding empty area when the empty area appears by rummaging food without eating the food, and it can be seen that the food is actually consumed only when the food weight is reduced.

FIG. 21 is a flowchart to explain the method of causing interest through a display when the guide type of a user is to concentrate eating and improve an unbalanced diet according to an embodiment of the present disclosure.

A child is likely to have irregular and instable meals due to an inattentive eating habit and thus, the electronic apparatus 100 may provide a screen to guide the user to concentrate on eating. To do so, the electronic apparatus 100 may not only display various contents but also set the method of displaying contents in various ways to make the user concentrate on eating.

Referring to FIG. 21, an image may be displayed in the form of puzzle to guide a child to concentrate on eating and improve an unbalanced eating by causing interest of the child.

First of all, when a user is identified at operation S2110 and user information of the identified user is acquired at operation S2120, the guide type of the electronic apparatus 100 may be determined based on the acquired user information. For example, if it is determined that the guide type set by the user is an unbalanced diet guide type or it is determined that the user needs to improve his or her unbalanced diet based on the user's diet history information, the electronic apparatus 100 may determine that the guide type of the electronic apparatus 100 is an unbalanced diet guide.

In other words, the electronic apparatus 100 determines whether the user needs to improve his or her unbalanced diet based on the user information at operation S2130, and if it is determined that the unbalanced diet needs to be improved at operation S2130:Y, the electronic apparatus 100 detects an empty area which is not covered by the food of the electronic apparatus 100 using an illumination sensor or a weight sensor at operation S2140. If there is an empty area at operation S2140:Y, the electronic apparatus 100 determines whether the weight of the food placed on the electronic apparatus 100 has been reduced using a weight sensor at operation S2150. In this case, if the weight has been reduced at operation S2150:Y, the electronic apparatus 100 may display image the corresponding image pieces on the empty area at operation S2160.

In addition, if the sensed food weight becomes 0 kg, the electronic apparatus 100 may determine that eating has been finished and display a message “I've enjoyed the meal”, etc. or various contents.

According to the above embodiment, by providing compensation for eating, it is possible to guide a child to eat food actively and to also provide the effect of improving an unbalanced diet.

Meanwhile, the electronic apparatus 100 may capture a user's posture when eating using a camera and evaluate the captured posture based on predetermined standards. Accordingly, the electronic apparatus 100 may provide a screen which guides the user to correct eating posture based on the evaluation result. For example, the electronic apparatus 100 may compare the user's eating posture with a standard eating posture and if the difference is more than a predetermined reference, may control to provide a notification screen or output notification sound.

If the user is a child, the electronic apparatus 100 may display a content for causing interest when the child's posture is corrected in order to provide compensation for correcting the posture.

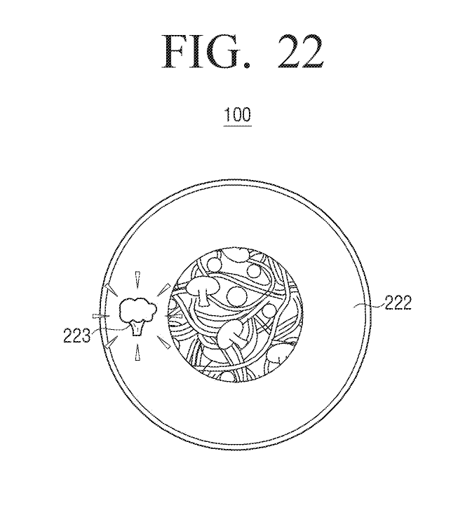

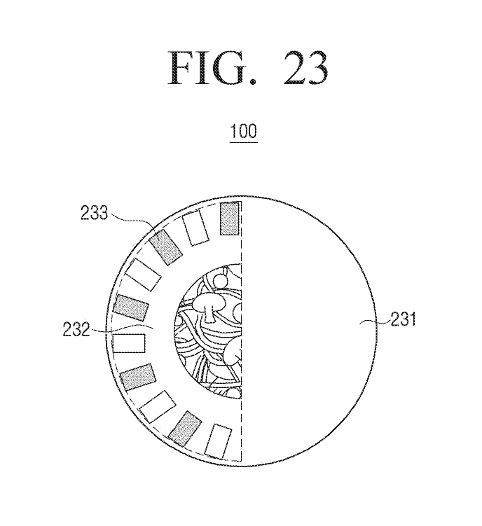

FIG. 22 is a view provided to explain a method of improving an unbalanced diet by increasing preference regarding a specific food unconsciously according to an embodiment of the present disclosure.

Referring to FIG. 22, a user may set user information regarding food with low preference in advance, and the electronic apparatus 100 may determine the type of food that the user does not eat much by analyzing the user's diet history information.

For example, if one of the food the user has low preference and does not eat is parsley, the electronic apparatus 100 may display the photo of parsley or an image 223 of parsley on an empty area 222 where food is not placed intermittently and repeatedly for less than 17 ms as illustrated in FIG. 22.

The above embodiment is based on a mere exposure effect (Robert Zjonc, 1980) that when a person is exposed to specific stimulation several times unconsciously, the preference regarding the stimulation increases. The electronic apparatus 100 according to an embodiment provides the effect of increasing the preference of food which the user does not eat well by setting the food the user does not like and simply exposing the user to the food unconsciously, thereby controlling the user's food preference unconsciously.

FIG. 23 is a view provided to explain a method of guiding the diet of a patient with brain dysfunction according to an embodiment of the present disclosure.

A patient with brain dysfunction where right parietal is impaired due to stroke, etc. may show hemi-neglect phenomenon. The patient with hemi-neglect phenomenon does not pay attention to an object or an event in the left side including the patient's body, so the patient has a tendency not to eat food on the dishes on the left side.

Referring to FIG. 23, the electronic apparatus 100 may divide the inner side where food is placed into a right area 231 and a left area 232, and may determine on which side of the food between the right area 231 and the left area 232 has been eaten by the user using an illumination sensor, a weight sensor, etc. If it is determined that only the food on the right area 231 has been eaten for a predetermined time and the food on the left area 232 has not been eaten, the electronic apparatus 100 may provide a visual feedback 233 such as flickering, etc. on the left area 232.

In addition, the electronic apparatus 100 may guide the user to eat the food on the left area 232 by providing an auditory feedback such as notification sound, etc. through a speaker 234 provided in the left side of the electronic apparatus 100.

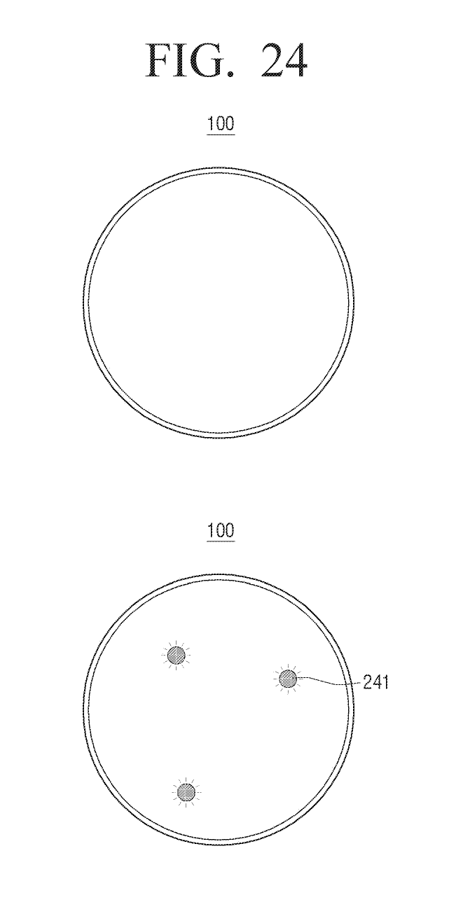

FIG. 24 is a view provided to explain a method of informing a user of a sanitary state of an electronic apparatus according to an embodiment of the present disclosure.

Referring to FIG. 24, the electronic apparatus 100 may sense a user's touch operation such as the operation of grabbing the electronic apparatus 100 by hand through a touch sensor, and sense foreign substances (or dirt) on the electronic apparatus 100 using illumination sensors which are distributed evenly on the inner side or the entire area of the electronic apparatus 100. If foreign substances are sensed, the sanitary state of the electronic apparatus 100 may be displayed through the display 110, or vibration or notification sound may be output.

For example, if an area 241 where the illumination value sensed by an illumination sensor is less than 70 lux is sensed, the electronic apparatus 100 may determine that there is a foreign substance on the corresponding area 241, and may inform the user by changing the state, such as by flickering the corresponding area 241 or changing the color thereof.

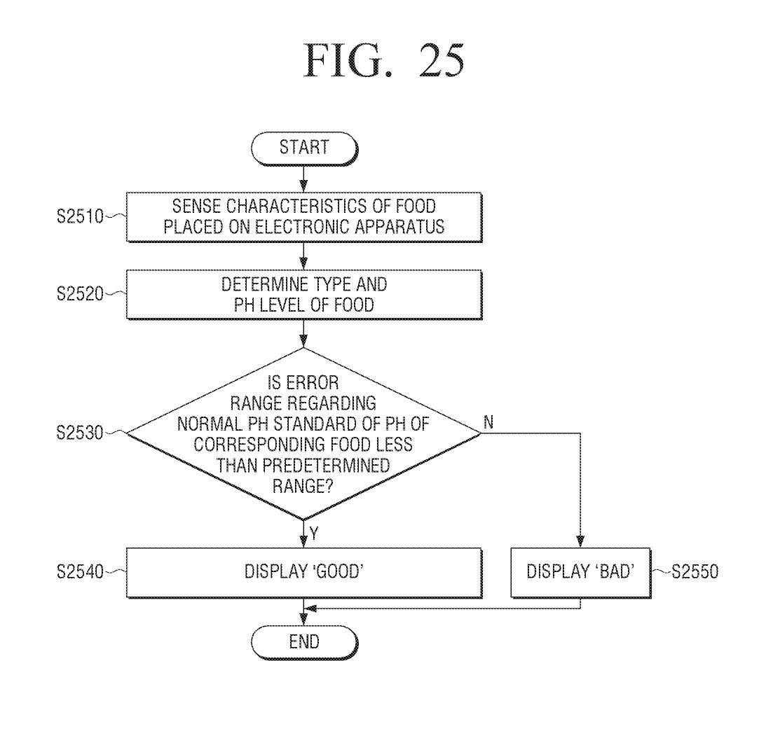

FIG. 25 is a view provided to explain a method of informing a user of freshness of food placed on an electronic apparatus according to an embodiment of the present disclosure.

Referring to FIG. 25, the electronic apparatus 100 may analyze the chemical ingredients of food placed on the electronic apparatus 100 and inform a user of the freshness of the food. Specifically, the electronic apparatus 100 senses characteristics of the food placed on the electronic apparatus 100 using at least one of a front camera, a pH sensor and an ingredient detector provided in the first element panel 23 at operation S2510. The electronic apparatus 100 may sense the type of food and the pH level of the food based on the sensed characteristics data at operation S2520.

In addition, the electronic apparatus 100 determines whether the error range of the measure pH level of the corresponding food in view of a normal pH reference value is less than a predetermined range based on the sensed pH characteristics of the food at operation S2530. In this case, if the error range is less than the predetermined range at operation S2530:Y, the electronic apparatus 100 may display the information that the food is fresh.

Specifically, the electronic apparatus 100 acquires a normal pH reference value regarding the determined food from pre-stored information regarding the normal pH reference value according to the type of food, and compares the normal pH reference value with the sensed pH level. In this case, if the error range between the normal pH and the sensed pH goes beyond a predetermined range, the electronic apparatus 100 may determine that the food goes bad and output a warning message.

For example, if the error range goes beyond a predetermined range at operation S2530:N, a warning message such as “Bad” may be displayed at operation S2550, and if the error range is less than the predetermined range at operation S2430:Y, the information that the food is fresh, such as “Good”, may be displayed at operation S2540.

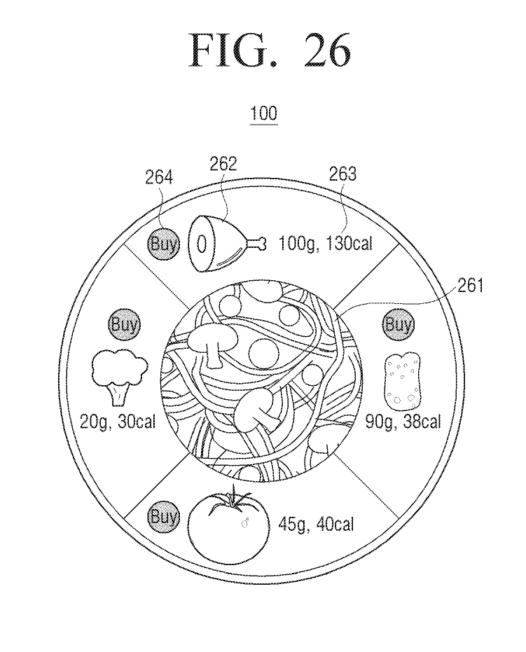

FIG. 26 is a view provided to explain an electronic apparatus which provides information regarding ingredients of food placed on an electronic apparatus and a purchase button according to an embodiment of the present disclosure.

Referring to FIG. 26, the electronic apparatus 100 may analyze ingredients of food 261 placed on the central part using the ingredient detector 35 and display information regarding the analyzed ingredients on the peripheral part which is divided into a plurality of areas, respectively. The information regarding the analyzed ingredients may include a representative image 262 and calorie information per unit weight 263 of the corresponding ingredients. In addition to the information regarding the analyzed ingredients, a purchase button 264 for purchasing the corresponding ingredients may be provided.

In addition, the electronic apparatus 100 may display an image corresponding to each ingredient, ingredient information and a purchase button around the electronic apparatus 100 using a projector (not illustrated) provided on the lower part of the electronic apparatus 100. Here, the projector is a subminiature beam projector, and may be realized as a wide-range projector including a wide-range lens which may provide a broad angle of view. Meanwhile, when a user clicks the purchase button, the user may proceed with purchasing the corresponding ingredient via wireless Internet connection.

According to an embodiment, a user may connect to an internet site to purchase insufficient food ingredients while having a meal after cooking and thus, user convenience can be improved.

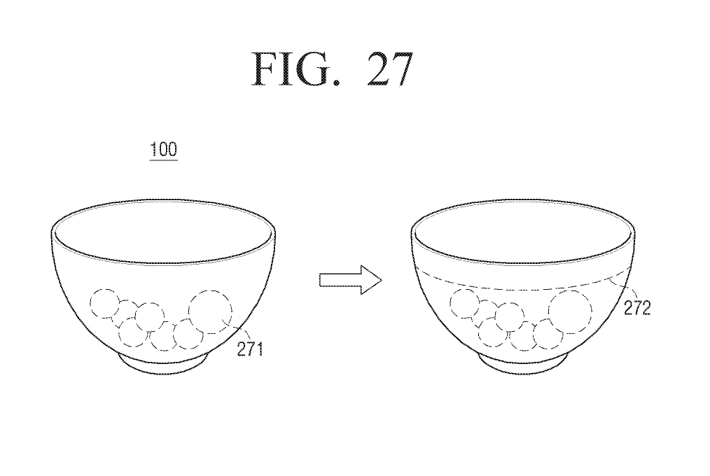

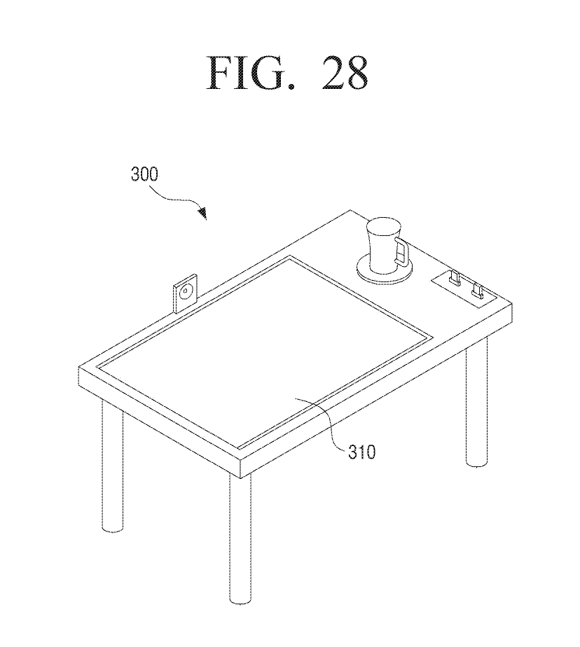

FIG. 27 is a view provided to explain an electronic apparatus which provides guidelines in consideration of food included in an electronic apparatus according to an embodiment of the present disclosure.

Referring to FIG. 27, the electronic apparatus 100 may be implemented as a bowl-type electronic bowl or smart bowl, and the food may be a cereal, snack, etc. which a user eats with milk. As illustrated in FIG. 27, the electronic apparatus 100 which is configured in the form of bowl may sense a cereal 271 in the electronic apparatus 100 using a front camera or the ingredient detector 35 provided in the first element panel 23, and provide guidelines 272 which display the height for milk to be filled up based on the weight of the cereal 271, which is analyzed through a weight sensor so that the user may pour an appropriate amount of milk.

In this case, the guidelines 272 may be displayed at a predetermined location corresponding to the weight of the cereal 271, and may be displayed on at least one display 110 between the inner side and the outer side of the electronic apparatus 100 where the cereal 271 is placed.

Accordingly, when the user eats food like the cereal 271, the user may pour an appropriate amount of milk to increase taste and also may reduce food waste.

FIG. 28 is a view provided to explain an operation method of an electronic apparatus which is implemented as a table according to an embodiment of the present disclosure.

Referring to FIG. 28, an electronic apparatus may be configured in the form of table where food utensils may be placed. Hereinafter, the electronic apparatus according to an embodiment of FIG. 28 will be referred to as an electronic table. An electronic table 300 may be implemented as a display 310 where the entire front area where food utensils displays user's dietary guide, or may have a structure where an installation hole is formed on the front side to be fitted with the display 310 which is exposed to outside.

The electronic table 300 may display a predetermined color corresponding to appetite increase or appetite loss based on user information regarding an identified user. In addition, the electronic table 300 may calculate coordinates where each utensil is placed on the display 310 using a weight sensor, an illumination sensor, etc. and display the user's dietary guide around each utensil.

For example, the electronic table 300 may set priority for each dish placed on the front side of the electronic apparatus 300, and if a user eats the food on a first dish according to the priority, change the color around a second dish, etc. in order to inform the user of the eating order. In this case, each dish includes a weight sensor, etc. to sense whether the food weight is reduced and inform the electronic table 300 about whether the food therein has been eaten.

Meanwhile, a camera may be provided horizontally or vertically on the front side of the electronic table 300, and if the camera is provided horizontally, the camera may be implemented as a wide-range camera or a fisheye camera to capture food placed on a dish on the table 300. The electronic table 300 may display the user's dietary guide on the display 310 based on the captured image.

For example, the electronic table 300 may recognize a representative color of the food from the captured image, and control the display 310 to display a complementary color regarding the recognized representative food color. In addition, the electronic table 300 may perform a search based on the captured image to acquire information regarding the type of the food placed on the dish, and display information regarding the calories of the corresponding food based on the acquired information.

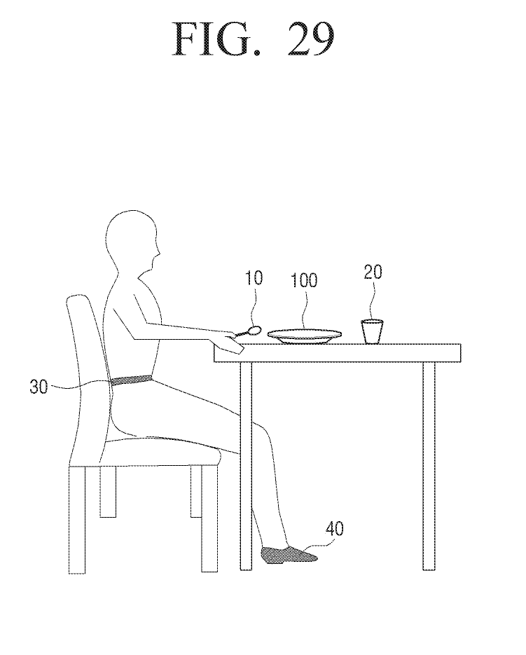

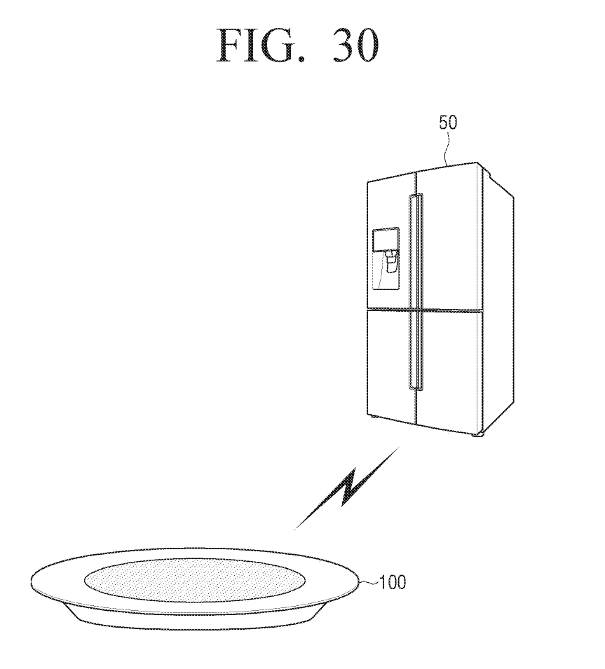

FIGS. 29 and 30 are views provided to explain an operation of an electronic apparatus which is linked to a wearable apparatus, etc. in internet of things environment according to an embodiment of the present disclosure.

Referring to FIG. 29, the electronic apparatus 100 may perform communication with various electronic apparatuses based on internet of things, and the electronic apparatuses based on internet of things may include a smart cup 20 or a wearable device such as a smart belt 30, smart shoes 40, etc. that a user wears.

The smart cup 20 is a device capable of measuring ingredients such as caffeine, fruit sugar, fat, etc. and calories regarding a beverage in the smart cup 20, and may transmit information regarding the measurement result to the electronic apparatus 100. Accordingly, the electronic apparatus 100 may measure the information regarding the amount of food that the user has consumed more accurately based on the received information and thus, may provide more accurate dietary guide to the user.

Meanwhile, the smart belt 30 may include a motor on a buckle to adjust the level of tightness based on the amount of the food that the user has eaten.

Specifically, the electronic apparatus 100 may transmit the information regarding the amount of the food that the user has eaten, which is generated based on sensing data, to the smart belt 30, and the smart belt 30 may adjust the level of tightness based on the received information. In addition, if the smart belt 30 receives information that the amount of the food that the user has eaten exceeds a guided amount from the electronic apparatus 100, the smart belt 30 may raise awareness by outputting an alarm through a speaker or vibration.

The smart shoes 40 may include an acceleration sensor, a pressure measuring device, a gyro sensor, etc., and may perform the function of checking the user's body condition and recommending the required amount of exercise.

The electronic apparatus 100 may transmit information regarding the amount of food that the user has eaten to the smart shoes 40, and the smart shoes 40 may calculate the required amount of exercise based on the received information. In addition, the electronic apparatus 100 may receive information regarding the user's amount of exercise for a day from the smart shoes 40, and provide a food intake guide based on the received information regarding the amount of exercise.

In addition, just like the smart belt 30, when receiving information that the amount of food that the user has eating exceeds a predetermined amount, the smart shoes 40 may output an alarm through a speaker or vibration.

Meanwhile, the wearable device which may be connected to the electronic apparatus 100 is not limited to the above-described smart belt 30 and the smart shoes 40, and may include various external apparatuses such as smart necklace, smart glasses, smart watch, smart spoon, smart chopsticks, head mounted display (HMD), etc.

For example, if the electronic apparatus 100 is linked to the food utensils 10 with a communication element through communication, such as smart spoon, smart chopsticks, etc., the electronic apparatus 100 may transmit the user's dietary guide to the smart spoon, the smart chopsticks, etc. Accordingly, the smart spoon or the smart chopsticks may provide a voice guide to guide the user's diet.

In addition, there may be case where the electronic apparatus 100 is linked to an external lighting device. In this case, the electronic apparatus 100 may transmit information to guide a user's diet, for example, information regarding a guide type, etc. to the external lighting device. For example, if the user's guide type relates to food intake control, the lighting device may control the color of lighting according to the guide type, etc. to provide the effect of increasing or decreasing the user's appetite.

If the electronic apparatus 100 is linked to an HMD, the effect of increasing or decreasing the user's appetite may be provided by changing the color filter of an HMD projection part.

FIG. 30 is a view provided to explain an operation of the electronic apparatus 100 which is linked to a smart refrigerator 50 according to an embodiment of the present disclosure.

Referring to FIG. 30, the smart refrigerator 50 may order ingredients, manage expiration date of food, search a recipe, etc. using an external touch LCD, and may be linked to the electronic apparatus 100 to change information.

For example, the electronic apparatus 100 may receive information regarding food stock from the smart refrigerator 50 and accordingly, a user may manage food in the refrigerator, a list of food to purchase, etc. conveniently through the electronic apparatus 100. In addition, the electronic apparatus 100 may receive information regarding food whose expiration date is approaching from the smart refrigerator 50, and may recommend food to cook in consideration of the food whose expiration date is approaching.

In addition, the electronic apparatus 100 may transmit information regarding the food that the user has eaten to the smart refrigerator 50, and the smart refrigerator 50 may manage food stock and recommend the food to cook based on the information received from the electronic apparatus 100.

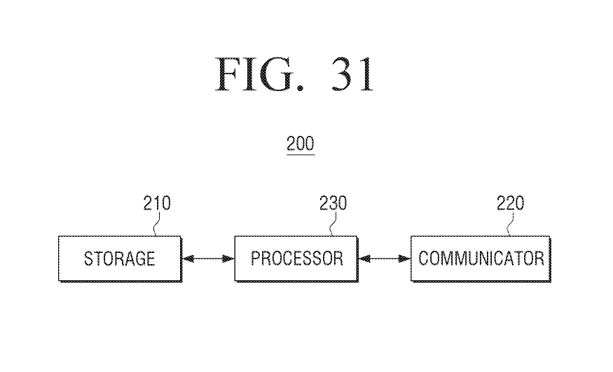

FIG. 31 is a block diagram illustrating configuration of a server which performs communication with an electronic apparatus briefly according to an embodiment of the present disclosure. A server 200 may be implemented as a web server, a cloud server, etc.

Referring to FIG. 31, the server 200 according to an embodiment includes a storage 210, a communicator 220 and a processor 230.

The storage 210 stores user information of a user.

The communicator 220 communicates with the electronic apparatus 100. Specifically, the communicator 220 may perform communication with the electronic apparatus 100 through various communication methods. For example, various communication networks such as 3^{rd} generation (3G), 4^{th} generation (4G), mobile communication network, Wi-Fi, ZigBee, the Institute of Electrical and Electronics Engineers (IEEE) wireless communication network, cloud network, etc. may be used.

The processor 230 controls the overall operations of the server 200. In particular, when food information corresponding to the characteristics of the food and user identification information is received from the electronic apparatus 100, the processor 230 may control to transmit the user's dietary guide to the electronic apparatus 100 based on the received food information and user information corresponding to the user identification information.

For example, if the electronic apparatus 100 captures food using a camera, the electronic apparatus 100 transmits the captured image to the server 300, and the processor 230 searches information regarding the corresponding food based on the received image. When the search is completed, the processor 230 may transmit information regarding the searched type of the food, calories, etc. to the electronic apparatus 100.

In addition, when the user identification information is received from the electronic apparatus 100, the processor 230 may acquire user information corresponding to the received user identification information from the storage 210.

Here, the user identification information may include at least one of the user's fingerprint recognition information, iris recognition information, face recognition information, vein recognition information, voice recognition information, and information input by the user.

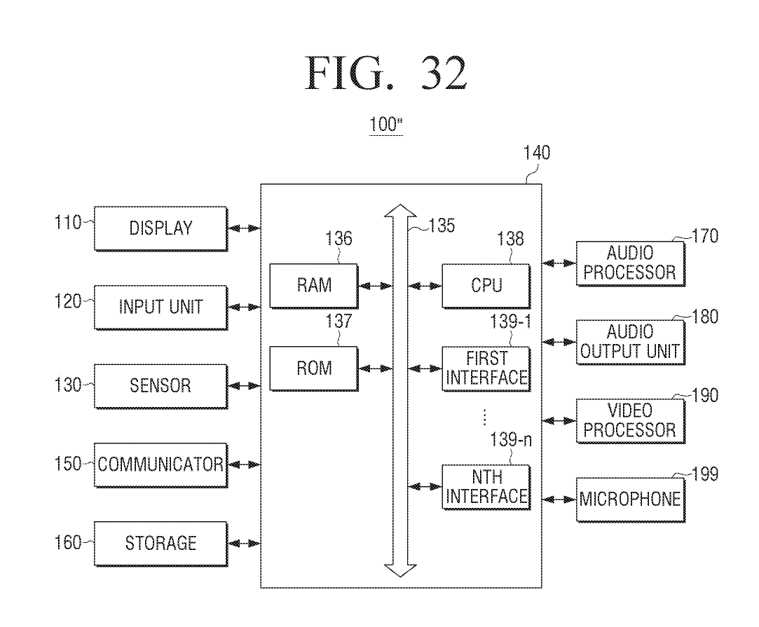

FIG. 32 is a block diagram illustrating configuration of an electronic apparatus in detail according to an embodiment of the present disclosure.

Referring to FIG. 32, an electronic apparatus 100″ according to an embodiment includes the display 110, the input unit 120, the sensor 130, the processor 140, the communicator 150, the storage 160, an audio processor 170, an audio output unit 180, a video processor 190 and a microphone 199. Hereinafter, the description regarding the elements which are overlapped with those in FIGS. 1A and 1B will not be provided.

The storage 160 stores user information of a plurality of users, and stores various modules to drive the electronic apparatus 100″.

Specifically, the storage 160 may store a base module which processes a signal transmitted from each hardware included in the electronic apparatus 100″, a storage module which manages database (DB) or registry, a security module, a communication module, etc. In addition, the storage 160 may further store a graphic processing module for generating a screen in various layouts, a user identification module for identifying a user based on user identification information, a movement processing module for processing information regarding a movement of the food utensils for eating food, a guide module for guiding a user's diet, etc.

The audio processor 170 processes audio data. However, the audio data processing may be performed by an audio processing module stored in the storage 160.

The audio output unit 180 outputs an audio signal. The audio output unit 180 may include a receiver terminal and a speaker.

The video processor 190 performs various image processing such as decoding of contents, scaling, noise filtering, framerate conversion, resolution conversion, etc. However, the video processing may be performed by a video processing module stored in the storage 160.

The microphone 199 is an element to input a user command or identify a user through voice recognition.

The processor 140 controls the overall operations of the electronic apparatus 100; using various modules stored in the storage 160.

As illustrated in FIG. 29, the processor 140 may include a random access memory (RAM) 136, a read only memory (ROM) 137, a central processing unit (CPU) 138, first to nth interfaces 139-1˜139-n, etc. and the RAM 136, the ROM 137, the CPU 138, the first to nth interfaces 139-1˜139-n, etc. may be connected to each other via a bus 135.

The ROM 137 stores a set of commands for system booting. The CPU 138 copies various application programs stored in the storage 160 in the RAM 136, and performs various operations by executing the application programs copied in the RAM 136.

The CPU 138 accesses the storage 160 to perform booting using the operating system (O/S) stored in the storage 160. Further, the CPU 138 performs various operations using various programs, contents, data, etc. stored in the storage 160.

In addition, the processor 140 performs graphic processing using a graphic processing module of the storage 160. The processor 140 generates a screen including various objects such as an icon, an image, a text, etc. Here, the operator operates attribute values, such as coordinate values, forms, sizes, and colors by which each object is displayed, according to a layout of the screen. The renderer generates a screen of various layouts including an object based on the attribute values calculated by the operator.

In addition, the processor 140 manages food that the user has eaten and food recommend to the user based on data regarding the sensed characteristics of the food using a food information processing module stored in the storage 160.

The processor 140 may analyze movement information of the food utensils 10 using a food utensil movement processing module stored in the storage 160 and trace or predict the movement of the food utensils 10. In addition, the processor 140 sets a dietary guide type based on user information of an identified user and the data regarding the sensed characteristics of food using a guide-type setting module stored in the storage 160.

The first to the nth interfaces 139-1˜139-n are connected to the above-described various elements. One of the interfaces may be a network interface which is connected to an external apparatus via network.

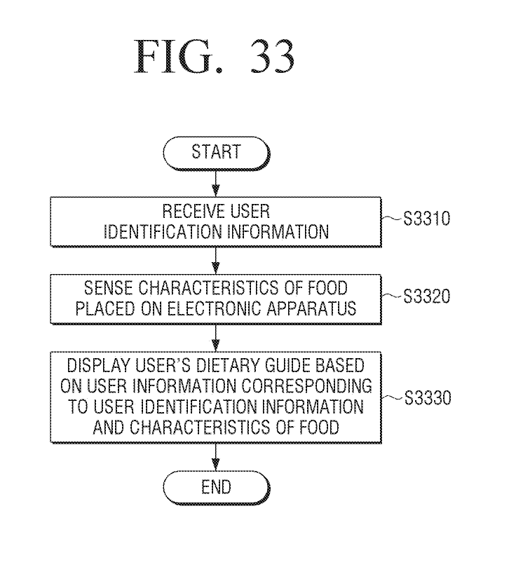

FIG. 33 is a flowchart provided to explain a method of controlling an electronic apparatus according to an embodiment of the present disclosure.

Referring to FIG. 33, first of all, user identification information is received at operation S3310. Subsequently, characteristics of the food placed on an electronic apparatus are sensed at operation S3320. Here, a user may be identified based on data acquired from the user identification information which is input directly from the user or data acquired by a biometric recognition sensor. In addition, at least one of the user identification information for identifying a user and user information regarding the identified user may be received from an external apparatus. Here, the information acquired by a biometric recognition sensor may include at least one of fingerprint recognition information, iris recognition information, vein recognition information, face recognition information and voice recognition information.

Subsequently, the user's dietary guide may be displayed based on the user information corresponding to the user identification information and the sensed characteristics of the food at operation S3330. Here, the user information may include at least one of the user's body information, the user's diet history information and the user's goal setting information. In addition, the guide type of the electronic apparatus 100 may be determined based on the user information of the identified user and the user's dietary guide may be displayed based on the determined guide type and the sensed characteristics of the food.

In this case, if the determined guide type is a food intake guide, a screen including the food intake guide may display a predetermined color corresponding to appetite increase or appetite loss on the entire area or a partial area of the display 110. In particular, the representative color of the food may be recognized based on the characteristics of the food placed on the electronic apparatus 100, and the effect of reducing appetite may be provided by displaying a complementary color with respect to the representative of the food on the entire area or a partial area of the inner side.

If the determined guide type is a food intake guide, the optical illusion effect regarding the amount of food may be provided by displaying the edge area of the inner side in predetermined transparency. In addition, if the determined guide type is a food intake guide, guidelines corresponding to the user's recommended food intake may be displayed.

If the determined guide type is a food intake guide, at least one of information on calories of food, information on the calories which have been consumed so far and information on minimum exercise required to burn the consumed calories.

If the determined guide type is an unbalanced diet guide, a visual feedback regarding the food which has been eaten the least may be provided.

According to the above-described various embodiments, a user's diet may be managed and guided on a long-term basis and thus, the user's diet may be improved and his or her heal may be enhanced.

The controlling method of an electronic apparatus according to the above-described various embodiments may be implemented as a program and stored in various recording media. In other words, a computer program which is processed by various processors and thus, is configured to execute the above-described various controlling methods may be stored and used in a recording medium.

For example, a non-transitory computer readable medium storing a program for receiving user identification information, sensing characteristics of the food placed on an electronic apparatus and displaying the user's dietary guide based on user information corresponding to the user identification information and the food characteristics may be provided.

The non-transitory recordable medium refers to a medium which may store data semi-permanently rather than storing data for a short time, such as register, cache, memory, etc. and is readable by an apparatus. Specifically, the above-described various applications and programs may be stored and provided in a non-transitory recordable medium such as compact disc (CD), digital versatile disc (DVD), hard disk, Blu-ray disc, universal serial bus (USB), memory card, ROM, etc.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. An electronic apparatus comprising:
a display;
an input device configured to receive user identification information;
a sensor configured to sense characteristics of food placed on the electronic apparatus; and
a processor configured to control to the display to display a user dietary guide based on user information corresponding to the user identification information and the characteristics of food.

2. The electronic apparatus as claimed in claim 1, wherein the display displays the user dietary guide one at least one of an outer side and an inner side of the electronic apparatus where food is placed.

3. The electronic apparatus as claimed in claim 2, wherein the display is implemented as at least one of a transparent display and a curved display having a curvature corresponding to a circumference of the electronic apparatus.

4. The electronic apparatus as claimed in claim 1, wherein the user information includes at least user's body information, user's dietary history information, and user's goal setting information.

5. The electronic apparatus as claimed in claim 1, wherein the user dietary guide includes at least one of a food intake guide, an unbalanced diet guide, and an eating speed guide.

6. The electronic apparatus as claimed in claim 5, wherein the processor is configured to control the display to display a screen including the food intake guide,
wherein the screen including the food intake guide displays a predetermined color or content corresponding to improvement of appetite or loss of appetite on an entire area or a partial area of the display.

7. The electronic apparatus as claimed in claim 5, wherein the processor is configured to control the display to display a screen including the food intake guide,
wherein the screen including the food intake guide is displayed such that an edge area of the display has predetermined transparency.

8. The electronic apparatus as claimed in claim 5, wherein the processor is configured to control the display to display the screen including the food intake guide,
wherein the screen including the food intake guide displays guidelines corresponding to the user's recommended intake.

9. The electronic apparatus as claimed in claim 5, wherein the processor is configured to control the display to display the screen including the food intake guide,
wherein the screen including the food intake guide displays at least one of calorie information of the food, calorie information of the food consumed so far and information on minimum exercise required to burn calorie intake.

10. The electronic apparatus as claimed in claim 5, wherein the processor is configured to control the display to display a screen including the unbalanced diet on the display,
wherein the screen including the unbalanced diet guide provides a visual feedback regarding food with less intake.

11. The electronic apparatus as claimed in claim 1, wherein the sensor includes at least one of a weight sensor and an illumination sensor, and
wherein the processor is configured to:
detect an area which is not covered by the food on the display using at least one of the weight sensor and the illumination sensor, and
control the display to display the user dietary guide on an area which is not covered by the food.

12. The electronic apparatus as claimed in claim 1, further comprising:
a transceiver configured to communicate with utensils for picking up food,
wherein the processor is configured to control the transceiver to provide a visual feedback corresponding to a user's dietary habit based on movement information of the utensils received through the communicator.

13. The electronic apparatus as claimed in claim 12, wherein the transceiver communicates with at least one of other electronic apparatuses,
wherein the processor is configured to control to provide a visual feedback corresponding to the user's dietary habit which is determined based on at least one of the movement information of the utensils and food intake information received from at least one of the other electronic apparatuses through the transceiver.

14. The electronic apparatus as claimed in claim 1, wherein the sensor includes at least one of a camera which captures the food placed on the electronic apparatus, an ingredient detector which detects ingredients of the food, a salinity sensor, a temperature sensor, a pH sensor, an illumination sensor, and a weight sensor.

15. The electronic apparatus as claimed in claim 14, further comprising:
a transceiver configured to communicate with a server,
wherein the processor is configured to:
control the transceiver to transmit a food image captured by the camera to the server,
control the transceiver to receive food information corresponding to the food image from the server, and
control the display to display the user's dietary guide corresponding to the received food information.

16. The electronic apparatus as claimed in claim 1, further comprising:
a memory,
wherein the processor is configured to control the display to display the user's dietary guide based on user information corresponding to the user identification information and the food characteristics from among user information stored in the memory.

17. The electronic apparatus as claimed in claim 17, wherein the input device includes a biometrics recognition sensor, and
wherein the user identification information is biometric information detected by the biometrics recognition sensor.

18. The electronic apparatus as claimed in claim 1, further comprising:
a transceiver configured to communicate with a server,
wherein the processor is configured to control the transceiver to transmit user identification information to the server and receive user information corresponding to the user identification information from the server.

19. A server comprising:
a memory configured to store user information;
a transceiver configured to communicate with an electronic apparatus where food is placed; and
a processor configured to control the transceiver to:
receive user identification information and food information corresponding to characteristics of the food from the electronic apparatus, and
transmit user's dietary guide displayed on a display of the electronic apparatus to the electronic apparatus based on user information corresponding to the user identification information and the food information.

20. A controlling method of an electronic apparatus, the controlling method comprising:
receiving user identification information;
sensing characteristics of food placed on the electronic apparatus; and
displaying a user's dietary guide based on user information corresponding to the user identification information and the characteristics of food.
